(19) United States
(12) Patent Application Publication
(10) Pub. No.: US 2016/0143279 A1
(43) Pub. Date: May 26, 2016

(54) Methods for Improving the Efficacy of Anionic Herbicides under Hard Water Conditions and Suitable Compositions

(71) Applicant: BASF SE, Ludwigshafen (DE)

(72) Inventors: John FRIHAUF, Raleigh, NC (US); Chad BROMMER, Raleigh, NC (US); Steven BOWE, Apex, NC (US); Glenn W. OLIVER, Apex, NC (US)

(73) Assignee: BASF SE, Ludwigshafen (DE)

(21) Appl. No.: 14/900,212

(22) PCT Filed: Jun. 18, 2014
(86) PCT No.: PCT/EP2014/062848

§ 371 Date: Dec. 21, 2015

Related U.S. Application Data
(60) Provisional application No. 61/839,397, filed on Jun. 26, 2013.

(30) Foreign Application Priority Data
Jun. 26, 2013 (EP) 13173803.1

(51) Int. Cl. A01N 37/02; A01N 37/10; A01N 25/02; A01N 57/20

(52) U.S. Cl. CPC A01N 37/02; A01N 57/20; A01N 37/10; A01N 25/02

(57) ABSTRACT

The present invention relates to a method for improving the efficacy of anionic herbicides (B) under hard water conditions, comprising the steps of
a) providing at least one anionic herbicide (B) and at least one aminocarboxylate (A), selected from the group consisting of methylglycine diacetate (MGDA; A1), glutamic acid diacetate (GLDA; A2), iminodisuccinate (IDS; A3), N-(2-hydroxyethyl)imino diacetate (HEIDA; A4), ethylenediamine-N,N′-disuccinate (EDDS; A5) and their salts;
b) diluting components (A) and (B) with water, wherein the concentration of dissolved calcium, magnesium, iron and aluminum salts in said water is more than 120 ppm; and
c) applying the diluted mixture to the area to be treated.

The present invention relates to a method for improving the efficacy of anionic herbicides (B) under hard water conditions, comprising the steps of
a) providing at least one anionic herbicide (B) and at least one aminocarboxylate (A), selected from the group consisting of methylglycine diacetate (MGDA; A1), glutamic acid diacetate (GLDA; A2), iminodisuccinate (IDS; A3), N-(2-hydroxyethyl)imino diacetate (HEIDA; A4), ethylenediamine-N,N′-disuccinate (EDDS; A5) and their salts;
b) diluting components (A) and (B) with water, wherein the concentration of dissolved calcium, magnesium, iron and aluminum salts in said water is more than 120 ppm; and
c) applying the diluted mixture to the area to be treated.

Furthermore, the present invention relates to the use of aminocarboxylates (A) selected from the group consisting of methylglycine diacetate (MGDA; A1), glutamic acid diacetate (GLDA; A2), iminodisuccinate (IDS; A3) N-(2-hydroxyethyl)imino diacetate (HEIDA; A4), ethylenediamine-N,N′-disuccinate (EDDS; A5) and their salts, for improving the efficacy of anionic herbicides (B) applied with hard water, wherein the concentration of dissolved calcium, magnesium, iron and aluminum salts in said water is more than 120 ppm.

In addition, the present invention relates to compositions comprising
a) one or more aminocarboxylate (A), selected from the group consisting of methylglycine diacetate (MGDA; A1), glutamic acid diacetate (GLDA; A2), iminodisuccinate (IDS; A3), N-(2-hydroxyethyl)imino diacetate (HEIDA; A4), ethylenediamine-N,N′-disuccinate (EDDS; A5) and their salts; and
b) at least one anionic herbicide (B);
   except compositions comprising exactly one herbicidal compound, which is selected from the group consisting of organic phosphates, organic phosphonates, organic phosphites and their respective salts; and
   except compositions comprising as aminocarboxylate (A) ethylenediamine-N,N′-disuccinate (EDDS; A5) and/or its salts and as anionic herbicide (B) exactly one herbicidal compound, which is selected from the group of water soluble selective auxin-type herbicides consisting of aminopyralid, clopyralid, 2,4-D, dicamba, dichlorprop, fluroxypyr, MCPA, mecoprop, picloram, quinclorac, quinmerac, triclopyr and their agriculturally useful derivatives; and
   except compositions comprising as aminocarboxylate (A) ethylenediamine-N,N′-disuccinate (EDDS; A5) and/or its salts and as anionic herbicide (B) a combination of 2,4-D, dicamba and mecoprop and/or their agriculturally useful derivatives.

Furthermore, the present invention relates to a process for the preparation of the compositions according to the invention.

It is known in the art that particular minerals present in water can have an adverse effect on herbicide activity. Often, herbicide concentrates are diluted in a spray tank with water before spraying the diluted herbicide to the area to be treated. Water quality is thus an important factor for herbicide efficacy. The concentration of mineral cations such as calcium (Ca²⁺), magnesium (Mg²⁺), iron (Fe³⁺, Fe²⁺), and aluminum (Al³⁺) in water, i.e. water hardness, may, next to suspended solids and organic matter, significantly impact herbicide performance. These minerals can bind with acidic herbicides resulting in reduced efficacy due to precipitation of herbicide molecules out of solution or decreased uptake of herbicide into the target plant.

Water hardness is a function of the amount of dissolved calcium, magnesium, iron and aluminum salts. The salts occur in a variety of forms but are typically calcium and magnesium bicarbonates (referred to as “temporary hardness”) and sulfates and chlorides (referred to as “permanent hardness”). The higher the concentration of these minerals in water, the harder the water.

The efficacy of glyphosate, an anionic herbicide, is known to be severely impaired upon dilution with hard water. In order to address this problem, it is recommended applying glyphosate together with considerable amounts of ammonium sulfate. Ammonium sulfate may enhance herbicide activity by increasing herbicide uptake or sequestration of hard water cations.

EP 0 290 416 discloses a typical concentrate comprising 74 g/l glyphosate (free acid), 49 g/l glyphosate monoisopropylammonium salt, 120 g/l fatty amine ethoxylate and 280 g/l ammonium sulfate (page 4, line 30ff.). Shea et al. describe in Weed Science, 1984, Vol. 32, 802-806, the reversal of cation-induced reduction of glyphosate activity with EDTA. WO2013/09225 discloses formulations containing amino-/polyaminocarboxylates and organic phosphates such as glyphosate and their use in agriculture. US2013/012383 relates to formulations comprising aminocarboxylates and at least one inorganic compound for the application to plants. Turner et al. describe complexing agents as herbicide additives in Weed Research, 1978, Vol. 18, 199-207.

U.S. Pat. No. 8,076,267 describes methods for treating undesired vegetation with compositions comprising auxin-type herbicides and an ethylenediaminedisuccinic compound.

It is an object of the present invention to identify compounds improving the efficacy of anionic herbicides, in particular to identify compounds improving the efficacy of anionic herbicides by overcoming the antagonistic effects of hard water on herbicide activity.

Another object of the present invention is providing a method for improving the efficacy of anionic herbicides under hard water conditions.

Another object of the present invention is providing compositions of anionic herbicides having an improved efficacy in comparison to known compositions of said anionic herbicides.

These and further objects were achieved by the compositions, methods and uses as described above.

In the context of the present invention, aminocarboxylates (A) are understood as meaning those organic compounds including either a tertiary amino group with one or two CH₂—COOH group(s), which can be partially or fully neutralized, or a secondary amino group with one or two CH(COOH)CH₂—COOH group(s), which can be partially or fully neutralized.

In the context of the present invention, the aminocarboxylates (A) are not complexed with a transition metal, such as copper, iron, manganese or zinc ions, and combinations thereof.

Preferred aminocarboxylates (A) are those organic compounds, whose chemical structure is based on an amino acid with a tertiary amino group carrying one or two CH₂—COOH group(s). In this context, amino acids may be selected among L-amino acids, R-amino acids and enantiomer mixtures of amino acids, for example the racemates.

Aminocarboxylates (A) may be present as free acid or in partially or fully neutralized form, i.e. as a salt. Preferably, compound (A) is present as a salt.

Suitable counterions are inorganic cations such as ammonium or alkali, preferably Na⁺, K⁺, or organic cations such as ammonium, substituted by one or more organic residues, in particular mono-C₁-C₄-alkylammonium, for example isopropylammonium, furthermore triethanolammonium, N,N-diethanolammonium, N-mono-C₁-C₄-alkyldiethanolammonium, for example N-methyldiethanolammonium or N-n-butyldiethanolammonium, and N,N-di-C₁-C₄-alkylethanolammonium, N,N-Bis(3-aminopropyl)methylammonium (BAPMA) and diethylenetriamine (DETA). Alkali metal ions are preferred, Na⁺ and K⁺ are especially preferred.

Preferably, aminocarboxylate (A) are selected from the group consisting of methylglycine diacetate (MGDA; A1), glutamic acid diacetate (GLDA; A2), iminodisuccinate (IDS; A3), N-(2-hydroxyethyl)imino diacetate (HEIDA; A4), ethylenediamine-N,N′-disuccinate (EDDS; A5) and their salts, preferably their alkali salts;

In one embodiment of the present invention, aminocarboxylates (A) are selected from the group consisting of methylglycine diacetate (A1), glutamic acid diacetate (A2) and their salts, preferably their alkali salts.

In another embodiment of the present invention, aminocarboxylates (A) are selected from the group consisting of iminodisuccinate (A3), N-(2-hydroxyethyl)imino diacetate (A4), ethylenediamine-N,N′-disuccinate (A5) and their salts, preferably their alkali salts.

In another embodiment of the present invention, the aminocarboxylate (A) is selected from iminodisuccinate (A3) and its salts, preferably its alkali salts.

In another embodiment of the present invention, aminocarboxylates (A) are selected from the group consisting of methylglycine diacetate (A1), glutamic acid diacetate (A2) and their salts, preferably their alkali salts, in particular their sodium and potassium salts.

In the context of the present invention, methylglycine diacetate trisodium salt is particularly preferred.

In the context of the present invention, methylglycine diacetate tripotassium salt is particularly preferred.

Compound (B) is an anionic herbicide. The term “anionic herbicide” refers to a herbicide, which is present as an anion. Preferably, anionic herbicides relate to herbicides comprising a protonizable hydrogen. More preferably, anionic herbicides relate to herbicides comprising a carboxylic, thiocarbonic, sulfonic, sulfinic, thiosulfonic or phosphorous acid group, especially a carboxylic acid group. The aforementioned groups may be partly present in neutral form including the protonizable hydrogen.

Usually, anions such as anionic herbicides comprise at least one anionic group. Preferably, the anionic herbicide comprises one or two anionic groups. In particular the anionic herbicide comprises exactly one anionic group. An example of an anionic group is a carboxylate group (—C(O)O⁻). The aforementioned anionic groups may be partly present in neutral form including the protonizable hydrogen. For example, the carboxylate group may be present partly in neutral form of carboxylic acid (—C(O)OH). This is preferably the case in aqueous compositions, in which an equilibrium of carboxylate and carboxylic acid may be present.

Suitable anionic herbicides are given in the following. In case the names refer to a neutral form or a salt of the anionic herbicide, the anionic form of the anionic herbicides are meant. For example, the anionic form of dicamba may be represented by the following formula:

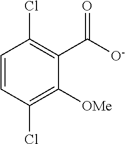 [SMILES: COc1c(Cl)ccc(Cl)c1C(=O)[O-]]

As another example, the anionic form of glyphosate may be represented by the following formula:

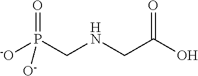

Suitable anionic herbicides are herbicides, which comprise a carboxylic, thiocarbonic, sulfonic, sulfinic, thiosulfonic or phosphorous acid group, especially a carboxylic acid group. Examples are aromatic acid herbicides, phenoxycarboxylic acid herbicides or organophosphorus herbicides comprising a carboxylic acid group.

In the context of the present invention, suitable anionic herbicides can be selected from the following groups (B1) to (B5) and their agriculturally useful derivatives:

Suitable aromatic acid herbicides are benzoic acid herbicides (B1), such as diflufenzopyr, naptalam, chloramben, dicamba, 2,3,6-trichlorobenzoic acid (2,3,6-TBA), tricamba; pyrimidinyloxybenzoic acid herbicides, such as bispyribac, pyriminobac; pyrimidinylthiobenzoic acid herbicides, such as pyrithiobac; phthalic acid herbicides, such as chlorthal; picolinic acid herbicides, such as aminopyralid, clopyralid, halauxifen, picloram; quinolinecarboxylic acid herbicides, such as quinclorac, quinmerac; or other aromatic acid herbicides, such as aminocyclopyrachlor. Preferred are benzoic acid herbicides, especially dicamba.

Suitable phenoxycarboxylic acid herbicides (B2) are phenoxyacetic herbicides, such as 4-chlorophenoxyacetic acid (4-CPA), (2,4-dichlorophenoxy)acetic acid (2,4-D), (3,4-dichlorophenoxy)acetic acid (3,4-DA), MCPA (4-(4-chloro-o-tolyloxy)butyric acid), MCPA-thioethyl, (2,4,5-trichlorophenoxy)acetic acid (2,4,5-T); phenoxybutyric herbicides, such as 4-CPB, 4-(2,4-dichlorophenoxy)butyric acid (2,4-DB), 4-(3,4-dichlorophenoxy)butyric acid (3,4-DB), 4-(4-chloro-o-tolyloxy)butyric acid (MCPB), 4-(2,4,5-trichlorophenoxy)butyric acid (2,4,5-TB); phenoxypropionic herbicides, such as cloprop, 2-(4-chlorophenoxy)propanoic acid (4-CPP), dichlorprop, dichlorprop-P, 4-(3,4-dichlorophenoxy)butyric acid (3,4-DP), fenoprop, mecoprop, mecoprop-P; aryloxyphenoxypropionic herbicides, such as chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, metamifop, propaquizafop, quizalofop, quizalofop-P, trifop. Preferred are phenoxyacetic herbicides, especially MCPA.

Suitable organophosphorus herbicides (B3) comprising a carboxylic acid group are bialafos, glufosinate, glufosinate-P, glyphosate. Preferred is glyphosate.

Suitable other herbicides (B4) comprising a carboxylic acid are pyridine herbicides comprising a carboxylic acid, such as fluroxypyr, triclopyr; triazolopyrimidine herbicides comprising a carboxylic acid, such as cloransulam; pyrimidinylsulfonylurea herbicides comprising a carboxylic acid, such as bensulfuron, chlorimuron, foramsulfuron, halosulfuron, mesosulfuron, primisulfuron, sulfometuron; imidazolinone herbicides, such as imazamethabenz, imazamethabenz, imazamox, imazapic, imazapyr, imazaquin and imazethapyr; triazolinone herbicides such as flucarbazone, propoxycarbazone and thiencarbazone; aromatic herbicides such as acifluorfen, bifenox, carfentrazone, flufenpyr, flumiclorac, fluoroglycofen, fluthiacet, lactofen, pyraflufen. Further on, chlorflurenol, dalapon, endothal, flamprop, flamprop-M, flupropanate, flurenol, oleic acid, pelargonic acid, TCA may be mentioned as other herbicides comprising a carboxylic acid.

Suitable other herbicides (B5) are herbicides that are weak acids, such as topramezone, tefuryltrione, pyrasulfotole, sulcotrione, fenquinotrione, bicyclopyrone, mesotrione, tembotrione, saflufenacil, fomesafen, halosafen, 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione (CAS 1258836-72-4), clethodim, sethoxydim, cycloxydim, profoxydim, tepraloxydim, tralkoxydim, amidosulfuron, azimsulfuron, bensulfuron, bensulfuron-methyl, chlorimuron, chlorimuron-ethyl, chlorsulfuron, cinosulfuron, cyclosulfamuron, ethametsulfuron, ethametsulfuron-methyl, ethoxysulfuron, flazasulfuron, flucetosulfuron, flupyrsulfuron, flupyrsulfuron-methyl, foramsulfuron, halosulfuron, halosulfuron-methyl, imazosulfuron, iodosulfuron, iodosulfuron-methyl, iofensulfuron, mesosulfuron, metazosulfuron, metsulfuron, metsulfuronmethyl, nicosulfuron, orthosulfamuron, oxasulfuron, primisulfuron, primisulfuron-methyl, propyrisulfuron, prosulfuron, pyrazosulfuron, pyrazosulfuron-ethyl, rimsulfuron, sulfometuron, sulfometuron-methyl, sulfosulfuron, thifensulfuron, thifensulfuron-methyl, triasulfuron, tribenuron, tribenuron-methyl, trifloxysulfuron, triflusulfuron, triflusulfuron-methyl, tritosulfuron, and bentazone.

In one embodiment of the present invention, compound (B) is selected from among herbicides, in particular those with activity against monocotyledonous or dicotyledonous weeds. Especially preferred are herbicides with activity against monocotyledonous and dicotyledonous weeds.

In another embodiment of the present invention, compound (B) is selected from the group consisting of dicamba, 2,4-D, quizalofop, quizalofop-P, glufosinate, glufosinate-P, glyphosate, sethoxydim, clethodim and their agriculturally useful derivatives.

In another embodiment of the present invention, compound (B) is selected from the group consisting of dicamba, 2,4-D, quizalofop, quizalofop-P, sethoxydim, clethodim and their agriculturally useful derivatives.

In another embodiment of the present invention, compound (B) is selected from the group consisting of quizalofop, quizalofop-P, sethoxydim, clethodim and their agriculturally useful derivatives.

In another embodiment of the present invention, compound (B) is selected from the group consisting of glyphosate and its salts. Especially preferred cations are K⁺, ammonium, isopropylammonium, BAPMA, DETA, diglycolamine (DGA) and monoethanolamine (MEA). In this context, glyphosate may be present in partially or fully neutralized form.

According to a preferred embodiment of the present invention, compound (B) is monoisopropylammonium glyphosate.

According to another preferred embodiment of the present invention, compound (B) is selected from the group consisting of dicamba and its agriculturally useful derivatives.

According to another preferred embodiment of the present invention, compound (B) is a combination of dicamba and glyphosate or their respective agriculturally useful derivatives.

Dicamba is a known herbicide, which may be present in form of a protonated acid, in form of a salt, or a mixture thereof. Various dicamba salts may be used, such as dicamba sodium, dicamba dimethylamine, dicamba diglyclolamine. Dicamba is available in the commercial products like BANVEL®+2,4-D, BANVEL HERBICIDE®, BANVEL-K+ATRAZINE®, BRUSHMASTER®, CELEBRITY PLUS®, CIMARRON MAX®, CLARITY HERBICIDE®, COOL POWER®, DIABLO HERBICIDE®, DICAMBA DMA SALT, DISTINCT HERBICIDE®, ENDRUN®, HORSEPOWER*®, LATIGO®, MARKSMAN HERBICIDE®, MACAMINE-D®, NORTHSTAR HERBICIDE®, OUTLAW HERBICIDE®, POWER ZONE®, PROKOZ VESSEL®, PULSAR®, Q4 TURF HERBICIDE®, RANGESTAR®, REQUIRE Q®, RIFLE®, RIFLE PLUS®, RIFLE-D®, SPEED ZONE®, STATUS HERBICIDE®, STER-LING BLUE®, STRUT®, SUPER TRIMEC*®, SURGE*®, TRIMEC BENTGRASS*®, TRIMEC CLASSIC*®, TRIMEC PLUS*®, TRIPLET SF®, TROOPER EXTRA®, VANQUISH®, VETERAN 720®, VISION HERBICIDE®, WEEDMASTER®, YUKON HERBICIDE®.

Preferably, dicamba is present in form of a dicamba polyamine salt and the polyamine has the formula (A1)

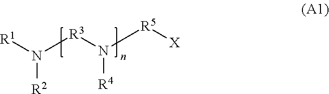

wherein R¹, R², R⁴, R⁶, and R⁷ are independently H or C₁-C₆-alkyl, which is optionally substituted with OH,
R³ and R⁵ are independently C₂-C₁₀-alkylene,
X is OH or NR⁶R⁷, and
n is from 1 to 20;
or the formula (A2)

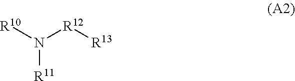

wherein R¹⁰ and R¹¹ are independently H or C₁-C₆-alkyl,
R¹² is C₁-C₁₂-alkylene, and
R¹³ is an aliphatic C₅-C₈ ring system, which comprises either nitrogen in the ring or which is substituted with at least one unit NR¹⁰R¹¹.

Particularly useful polyamine salts of dicamba are described in WO11/039172.

In the context of the present invention, dicamba in form of a N,N-bis(3-aminopropyl)methylamine (so called “BAPMA”) salt is especially preferred.

In the context of the present invention, the following compositions are particularly useful:

Compositions (I) comprising
a) methylglycine diacetate (MGDA; A1) and/or its salts; and
b) at least one anionic herbicide (B) and/or their agriculturally useful derivatives.
   Compositions (II) comprising
a) methylglycine diacetate (MGDA; A1) and/or its salts; and
b) at least one anionic herbicide (B) and/or their agriculturally useful derivatives;
except compositions comprising exactly one herbicidal compound, which is selected from the group consisting of organic phosphates, organic phosphonates, organic phosphites and their respective salts.
   Compositions (Ia) comprising
a) methylglycine diacetate (MGDA; A1) and/or its salts; and
b) at least one anionic herbicide (B) selected from dicamba, 2,4-D, quizalofop, quizalofop-P, glufosinate, glufosinate-P, glyphosate, sethoxydim, clethodim and their agriculturally useful derivatives.
   Compositions (IIa) comprising
a) methylglycine diacetate (MGDA; A1) and/or its salts; and
b) at least one anionic herbicide (B) selected from dicamba, 2,4-D, quizalofop, quizalofop-P, sethoxydim, clethodim and their agriculturally useful derivatives.
   Compositions (IIb) comprising
a) methylglycine diacetate (MGDA; A1) and/or its salts; and
b) dicamba or a combination of dicamba and glyphosate or their respective agriculturally useful derivatives.
   Compositions (III) comprising
a) glutamic acid diacetate (GLDA; A2) and/or its salts; and
b) at least one anionic herbicide (B) and/or their agriculturally useful derivatives.
   Compositions (IV) comprising
a) glutamic acid diacetate (GLDA; A2) and/or its salts; and
b) at least one anionic herbicide (B) and/or their agriculturally useful derivatives;
except compositions comprising exactly one herbicidal compound, which is selected from the group consisting of organic phosphates, organic phosphonates, organic phosphites and their respective salts.
   Compositions (IIIa) comprising
a) glutamic acid diacetate (GLDA; A2) and/or its salts; and
b) at least one anionic herbicide (B) selected from dicamba, 2,4-D, quizalofop, quizalofop-P, glufosinate, glufosinate-P, glyphosate, sethoxydim, clethodim and their agriculturally useful derivatives.
   Compositions (IVa) comprising
a) glutamic acid diacetate (GLDA; A2) and/or its salts; and
b) at least one anionic herbicide (B) selected from dicamba, 2,4-D, quizalofop, quizalofop-P, sethoxydim, clethodim and their agriculturally useful derivatives.
   Compositions (V) comprising
a) iminodisuccinate (IDS; A3) and/or its salts; and
b) at least one anionic herbicide (B) and/or their agriculturally useful derivatives.
   Compositions (VI) comprising
a) iminodisuccinate (IDS; A3) and/or its salts; and
b) at least one anionic herbicide (B) and/or their agriculturally useful derivatives;
except compositions comprising exactly one herbicidal compound, which is selected from the group consisting of organic phosphates, organic phosphonates, organic phosphites and their respective salts.
   Compositions (Va) comprising
a) iminodisuccinate (IDS; A3) and/or its salts; and
b) at least one anionic herbicide (B) selected from dicamba, 2,4-D, quizalofop, quizalofop-P, glufosinate, glufosinate-P, glyphosate, sethoxydim, clethodim and their agriculturally useful derivatives.
   Compositions (VIa) comprising
a) iminodisuccinate (IDS; A3) and/or its salts; and
b) at least one anionic herbicide (B) selected from dicamba, 2,4-D, quizalofop, quizalofop-P, sethoxydim, clethodim and their agriculturally useful derivatives.
   Compositions (VII) comprising
a) N-(2-hydroxyethyl)imino diacetate (HEIDA; A4) and/or its salts; and
b) at least one anionic herbicide (B) and/or their agriculturally useful derivatives.
   Compositions (VIII) comprising
a) N-(2-hydroxyethyl)imino diacetate (HEIDA; A4) and/or its salts; and
b) at least one anionic herbicide (B) and/or their agriculturally useful derivatives;
except compositions comprising exactly one herbicidal compound, which is selected from the group consisting of organic phosphates, organic phosphonates, organic phosphites and their respective salts.
   Compositions (VIIa) comprising
a) N-(2-hydroxyethyl)imino diacetate (HEIDA; A4) and/or its salts; and
b) at least one anionic herbicide (B) selected from dicamba, 2,4-D, quizalofop, quizalofop-P, glufosinate, glufosinate-P, glyphosate, sethoxydim, clethodim and their agriculturally useful derivatives.
   Compositions (VIIIa) comprising
a) N-(2-hydroxyethyl)imino diacetate (HEIDA; A4) and/or its salts; and
b) at least one anionic herbicide (B) selected from dicamba, 2,4-D, quizalofop, quizalofop-P, sethoxydim, clethodim and their agriculturally useful derivatives.
   Compositions (IX) comprising
a) ethylenediamine-N,N′-disuccinate (EDDS; A5) and/or its salts; and
b) at least one anionic herbicide (B) and/or their agriculturally useful derivatives.
   Compositions (X) comprising
a) ethylenediamine-N,N′-disuccinate (EDDS; A5) and/or its salts; and
b) at least one anionic herbicide (B) and/or their agriculturally useful derivatives;
except compositions comprising exactly one herbicidal compound, which is selected from the group consisting of organic phosphates, organic phosphonates, organic phosphites and their respective salts; and
except compositions comprising exactly one herbicidal compound, which is selected from the group of water soluble selective auxin-type herbicides consisting of aminopyralid, clopyralid, 2,4-D, dicamba, dichlorprop, fluroxypyr, MCPA, mecoprop, picloram, quinclorac, quinmerac, triclopyr and their agriculturally useful derivatives; and
except compositions comprising a combination of 2,4-D, dicamba and mecoprop and/or their agriculturally useful derivatives.
   Compositions (IXa) comprising
a) ethylenediamine-N,N′-disuccinate (EDDS; A5) and/or its salts; and
b) at least one anionic herbicide (B) selected from dicamba, 2,4-D, quizalofop, quizalofop-P, glufosinate, glufosinate-P, glyphosate, sethoxydim, clethodim and their agriculturally useful derivatives.
   Compositions (Xa) comprising
a) ethylenediamine-N,N′-disuccinate (EDDS; A5) and/or its salts; and
b) at least one anionic herbicide (B) selected from dicamba, 2,4-D, quizalofop, quizalofop-P, sethoxydim, clethodim and their agriculturally useful derivatives;
except compositions comprising exactly one herbicidal compound, which is selected from the group of water soluble selective auxin-type herbicides consisting of 2,4-D, dicamba and their agriculturally useful derivatives; and
except compositions comprising a combination of 2,4-D, dicamba and mecoprop and/or their agriculturally useful derivatives.

In the context of the present invention, the following compositions are especially preferred:

Compositions (XI) comprising
a) methylglycine diacetate trisodium salt; and
b) dicamba and/or its agriculturally useful salts.
   Compositions (XII) comprising
a) methylglycine diacetate tripotassium salt; and
b) dicamba and/or its agriculturally useful salts.
   Compositions (XIII) comprising
a) methylglycine diacetate trisodium salt; and
b) a combination of dicamba, glyphosate and/or their agriculturally useful salts.
   Compositions (XIV) comprising
a) methylglycine diacetate tripotassium salt; and
b) a combination of dicamba, glyphosate and/or their agriculturally useful salts.

In the context of the present invention, the aminocarboxylates (A) are not complexed with a transition metal, such as copper, iron, manganese or zinc ions, and combinations thereof. Accordingly, the compositions of the present invention are essentially free of transition metals. Essentially free is to be understood as less than 1% w/w, preferably less than 0.1% w/w, more preferably less than 0.01% w/w, most preferably less than 0.005% w/w in the compositions according to the present invention.

Aminocarboxylates (A) as defined herein are useful for improving the efficacy of anionic herbicides (B). They are particularly useful for improving the efficacy of anionic herbicides (B) under hard water conditions.

Depending on the concentration of dissolved calcium, magnesium, iron and aluminum salts, water can be classified as soft water (0-60 ppm), moderately hard water (61-120 ppm), hard water (121-180 ppm) and very hard water (>181 ppm).

According to one embodiment of the present invention, aminocarboxylates (A) are useful for improving the efficacy of anionic herbicides (B) under hard water conditions, wherein the water has a concentration of dissolved calcium, magnesium, iron and aluminum salts of more than 61 ppm.

According to another embodiment of the present invention, aminocarboxylates (A) are useful for improving the efficacy of anionic herbicides (B) under hard water conditions, wherein the water has a concentration of dissolved calcium, magnesium, iron and aluminum salts of more than 121 ppm.

According to another embodiment of the present invention, aminocarboxylates (A) are useful for improving the efficacy of anionic herbicides (B) under hard water conditions, wherein the water has a concentration of dissolved calcium, magnesium, iron and aluminum salts of more than 181 ppm.

According to another embodiment of the present invention, aminocarboxylates (A) are useful for improving the efficacy of anionic herbicides (B) under hard water conditions, wherein the water has a concentration of dissolved calcium, magnesium, iron and aluminum salts of more than 300 ppm.

According to another embodiment of the present invention, aminocarboxylates (A) are useful for improving the efficacy of anionic herbicides (B) under hard water conditions, wherein the water has a concentration of dissolved calcium salts of more than 181 ppm.

According to another embodiment of the present invention, aminocarboxylates (A) are useful for improving the efficacy of anionic herbicides (B) under hard water conditions, wherein the water has a concentration of dissolved calcium salts of more than 300 ppm.

In the compositions according to the present invention, the aminocarboxylate (A) is present at a concentration of 0.1 to 25% w/w.

In the compositions according to the present invention, the anionic herbicide (B) is present at a concentration of 0.00001 to 20% w/w.

In order to enlarge the spectrum of weed control and/or in order to obtain synergistic herbicidal effects, the compositions according the invention may comprise or may be applied together with further herbicidally active compounds C (herbicide C) such as:

c1) from the group of the lipid biosynthesis inhibitors:
ACC-herbicides such as alloxydim, alloxydim-sodium, butroxydim, clethodim, clodinafop, clodinafop-propargyl, cycloxydim, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-methyl, haloxyfop-P, haloxyfop-P-methyl, metamifop, pinoxaden, profoxydim, propaquizafop, quizalofop, quizalofop-ethyl, quizalofop-tefuryl, quizalofop-P, quizalofop-P-ethyl, quizalofop-P-tefuryl, sethoxydim, tepraloxydim, tralkoxydim, 4-(4′-Chloro-4-cyclopropyl-2′-fluoro[1,1′-biphenyl]-3-yl)-5-hydroxy-2,2,6,6-tetramethyl-2H-pyran-3(6H)-one (CAS 1312337-72-6); 4-(2′,4′-Dichloro-4-cyclopropyl[1, 1′-biphenyl]-3-yl)-5-hydroxy-2,2,6,6-tetramethyl-2H-pyran-3(6H)-one (CAS 1312337-45-3); 4-(4′-Chloro-4-ethyl-2′-fluoro[1,1′-biphenyl]-3-yl)-5-hydroxy-2,2,6,6-tetramethyl-2H-pyran-3(6H)-one (CAS 1033757-93-5); 4-(2′,4′-Dichloro-4-ethyl[1,1′-biphenyl]-3-yl)-2,2,6,6-tetramethyl-2H-pyran-3,5(4H,6H)-dione (CAS 1312340-84-3); 5-(Acetyloxy)-4-(4′-chloro-4-cyclopropyl-2′-fluoro[1,1′-biphenyl]-3-yl)-3,6-dihydro-2,2,6,6-tetramethyl-2H-pyran-3-one (CAS 1312337-48-6); 5-(Acetyloxy)-4-(2′,4′-dichloro-4-cyclopropyl-[1,1′-biphenyl]-3-yl)-3,6-dihydro-2,2,6,6-tetramethyl-2H-pyran-3-one; 5-(Acetyloxy)-4-(4′-chloro-4-ethyl-2′-fluoro[1,1′-biphenyl]-3-yl)-3,6-dihydro-2,2,6,6-tetramethyl-2H-pyran-3-one (CAS 1312340-82-1); 5-(Acetyloxy)-4-(2′,4′-dichloro-4-ethyl[1,1′-biphenyl]-3-yl)-3,6-dihydro-2,2,6,6-tetramethyl-2H-pyran-3-one (CAS 1033760-55-2); 4-(4′-Chloro-4-cyclopropyl-2′-fluoro[1, 1′-biphenyl]-3-yl)-5,6-dihydro-2,2,6,6-tetramethyl-5-oxo-2H-pyran-3-yl carbonic acid methyl ester (CAS 1312337-51-1); 4-(2′,4′-Dichloro-4-cyclopropyl-[1,1′-biphenyl]-3-yl)-5,6-dihydro-2,2,6,6-tetramethyl-5-oxo-2H-pyran-3-yl carbonic acid methyl ester; 4-(4′-Chloro-4-ethyl-2′-fluoro[1,1′-biphenyl]-3-yl)-5,6-dihydro-2,2,6,6-tetramethyl-5-oxo-2H-pyran-3-yl carbonic acid methyl ester (CAS 1312340-83-2); 4-(2′,4′-Dichloro-4-ethyl[1,1′-biphenyl]-3-yl)-5,6-dihydro-2,2,6,6-tetramethyl-5-oxo-2H-pyran-3-yl carbonic acid methyl ester (CAS 1033760-58-5); and non ACC herbicides such as benfuresate, butylate, cycloate, dalapon, dimepiperate, EPTC, esprocarb, ethofumesate, flupropanate, molinate, orbencarb, pebulate, prosulfocarb, TCA, thiobencarb, tiocarbazil, triallate and vernolate;
c2) from the group of the ALS inhibitors:
sulfonylureas such as amidosulfuron, azimsulfuron, bensulfuron, bensulfuron-methyl, chlorimuron, chlorimuron-ethyl, chlorsulfuron, cinosulfuron, cyclosulfamuron, ethametsulfuron, ethametsulfuron-methyl, ethoxysulfuron, flazasulfuron, flucetosulfuron, flupyrsulfuron, flupyrsulfuron-methyl-sodium, foramsulfuron, halosulfuron, halosulfuron-methyl, imazosulfuron, iodosulfuron, iodosulfuron-methyl-sodium, iofensulfuron, iofensulfuron-sodium, mesosulfuron, metazosulfuron, metsulfuron, metsulfuron-methyl, nicosulfuron, orthosulfamuron, oxasulfuron, primisulfuron, primisulfuron-methyl, propyrisulfuron, prosulfuron, pyrazosulfuron, pyrazosulfuron-ethyl, rimsulfuron, sulfometuron, sulfometuron-methyl, sulfosulfuron, thifensulfuron, thifensulfuron-methyl, triasulfuron, tribenuron, tribenuron-methyl, trifloxysulfuron, triflusulfuron, triflusulfuron-methyl and tritosulfuron,
imidazolinones such as imazamethabenz, imazamethabenz-methyl, imazamox, imazapic, imazapyr, imazaquin and imazethapyr, triazolopyrimidine herbicides and sulfonanilides such as cloransulam, cloransulam-methyl, diclosulam, flumetsulam, florasulam, metosulam, penoxsulam, pyrimisulfan and pyroxsulam,
pyrimidinylbenzoates such as bispyribac, bispyribac-sodium, pyribenzoxim, pyriftalid, pyriminobac, pyriminobac-methyl, pyrithiobac, pyrithiobac-sodium, 4-[[[2-[(4,6-dimethoxy-2-pyrimidinyl)oxy]phenyl]methyl]amino]-benzoic acid-1-methylethyl ester (CAS 420138-41-6), 4-[[[2-[(4,6-dimethoxy-2-pyrimidinyl)oxy]phenyl]methyl]amino]-benzoic acid propyl ester (CAS 420138-40-5), N-(4-bromophenyl)-2-[(4,6-dimethoxy-2-pyrimidinyl)oxy]benzenemethanamine (CAS 420138-01-8),
sulfonylaminocarbonyl-triazolinone herbicides such as flucarbazone, flucarbazone-sodium, propoxycarbazone, propoxycarbazone-sodium, thiencarbazone and thiencarbazone-methyl; and triafamone;
among these, a preferred embodiment of the invention relates to those compositions comprising at least one imidazolinone herbicide;
c3) from the group of the photosynthesis inhibitors:
amicarbazone, inhibitors of the photosystem II, e.g. triazine herbicides, including of chlorotriazine, triazinones, triazindiones, methylthiotriazines and pyridazinones such as ametryn, atrazine, chloridazone, cyanazine, desmetryn, dimethametryn, hexazinone, metribuzin, prometon, prometryn, propazine, simazine, simetryn, terbumeton, terbuthylazin, terbutryn and trietazin, aryl urea such as chlorobromuron, chlorotoluron, chloroxuron, dimefuron, diuron, fluometuron, isoproturon, isouron, linuron, metamitron, methabenzthiazuron, metobenzuron, metoxuron, monolinuron, neburon, siduron, tebuthiuron and thiadiazuron, phenyl carbamates such as desmedipham, karbutilat, phenmedipham, phenmedipham-ethyl, nitrile herbicides such as bromofenoxim, bromoxynil and its salts and esters, ioxynil and its salts and esters, uraciles such as bromacil, lenacil and terbacil, and bentazon and bentazon-sodium, pyridate, pyridafol, pentanochlor and propanil and inhibitors of the photosystem I such as diquat, diquat-dibromide, paraquat, paraquat-dichloride and paraquat-dimetilsulfate. Among these, a preferred embodiment of the invention relates to those compositions comprising at least one aryl urea herbicide. Among these, likewise a preferred embodiment of the invention relates to those compositions comprising at least one triazine herbicide. Among these, likewise a preferred embodiment of the invention relates to those compositions comprising at least one nitrile herbicide;
c4) from the group of the protoporphyrinogen-IX oxidase inhibitors:
acifluorfen, acifluorfen-sodium, azafenidin, bencarbazone, benzfendizone, bifenox, butafenacil, carfentrazone, carfentrazone-ethyl, chlomethoxyfen, cinidon-ethyl, fluazolate, flufenpyr, flufenpyr-ethyl, flumiclorac, flumiclorac-pentyl, flumioxazin, fluoroglycofen, fluoroglycofen-ethyl, fluthiacet, fluthiacet-methyl, fomesafen, halosafen, lactofen, oxadiargyl, oxadiazon, oxyfluorfen, pentoxazone, profluazol, pyraclonil, pyraflufen, pyraflufen-ethyl, saflufenacil, sulfentrazone, thidiazimin, tiafenacil, ethyl[3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate (CAS 353292-31-6; S-3100), N-ethyl-3-(2,6-dichloro-4-trifluoromethylphenoxy)-5-methyl-1H-pyrazole-1-carboxamide (CAS 452098-92-9), N-tetrahydrofurfuryl-3-(2,6-dichloro-4-trifluoromethylphenoxy)-5-methyl-1H-pyrazole-1-carboxamide (CAS 915396-43-9), N-ethyl-3-(2-chloro-6-fluoro-4-trifluoromethylphenoxy)-5-methyl-1H-pyrazole-1-carboxamide (CAS 452099-05-7), N-tetrahydrofurfuryl-3-(2-chloro-6-fluoro-4-trifluoromethylphenoxy)-5-methyl-1H-pyrazole-1-carboxamide (CAS 452100-03-7), 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione, 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione (CAS 1258836-72-4), 2-(2,2,7-Trifluoro-3-oxo-4-prop-2-ynyl-3,4-dihydro-2H-benzo[1,4]oxazin-6-yl)-4,5,6,7-tetrahydro-isoindole-1,3-dione, 1-Methyl-6-trifluoromethyl-3-(2,2,7-trifluoro-3-oxo-4-prop-2-ynyl-3,4-dihydro-2H-benzo[1,4]oxazin-6-yl)-1H-pyrimidine-2,4-dione, methyl (E)-4-[2-chloro-5-[4-chloro-5-(difluoromethoxy)-1H-methyl-pyrazol-3-yl]-4-fluoro-phenoxy]-3-methoxy-but-2-enoate [CAS 948893-00-3], and 3-[7-Chloro-5-fluoro-2-(trifluoromethyl)-1H-benzimidazol-4-yl]-1-methyl-6-(trifluoromethyl)-1H-pyrimidine-2,4-dione (CAS 212754-02-4);
c5) from the group of the bleacher herbicides:
PDS inhibitors: beflubutamid, diflufenican, fluridone, flurochloridone, flurtamone, norflurazon, picolinafen, and 4-(3-trifluoromethylphenoxy)-2-(4-trifluoromethylphenyl)pyrimidine (CAS 180608-33-7), HPPD inhibitors: benzobicyclon, benzofenap, clomazone, isoxaflutole, mesotrione, pyrasulfotole, pyrazolynate, pyrazoxyfen, sulcotrione, tefuryltrione, tembotrione, topramezone and bicyclopyrone, bleacher, unknown target: aclonifen, amitrole and flumeturon;
c6) from the group of the EPSP synthase inhibitors:
glyphosate, glyphosate-isopropylammonium, glyposate-potassium and glyphosate-trimesium (sulfosate);
c7) from the group of the glutamine synthase inhibitors:
bilanaphos (bialaphos), bilanaphos-sodium, glufosinate, glufosinate-P and glufosinate-ammonium;
c8) from the group of the DHP synthase inhibitors:
asulam;
c9) from the group of the mitosis inhibitors:
compounds of group K1: dinitroanilines such as benfluralin, butralin, dinitramine, ethalfluralin, fluchloralin, oryzalin, pendimethalin, prodiamine and trifluralin, phosphoramidates such as amiprophos, amiprophos-methyl, and butamiphos, benzoic acid herbicides such as chlorthal, chlorthal-dimethyl, pyridines such as dithiopyr and thiazopyr, benzamides such as propyzamide and tebutam; compounds of group K2: chlorpropham, propham and carbetamide, among these, compounds of group K1, in particular dinitroanilines are preferred;
c10) from the group of the VLCFA inhibitors:
chloroacetamides such as acetochlor, alachlor, butachlor, dimethachlor, dimethenamid, dimethenamid-P, metazachlor, metolachlor, metolachlor-S, pethoxamid, pretilachlor, propachlor, propisochlor and thenylchlor, oxyacetanilides such as flufenacet and mefenacet, acetanilides such as diphenamid, naproanilide and napropamide, tetrazolinones such fentrazamide, and other herbicides such as anilofos, cafenstrole, fenoxasulfone, ipfencarbazone, piperophos, pyroxasulfone and isoxazoline compounds of the formulae II.1, II.2, II.3, II.4, II.5, II.6, II.7, II.8 and II.9

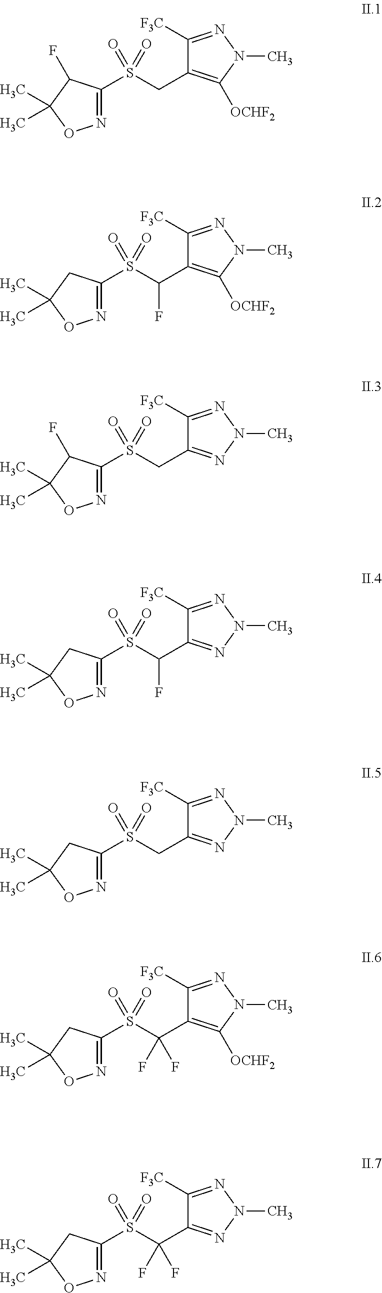

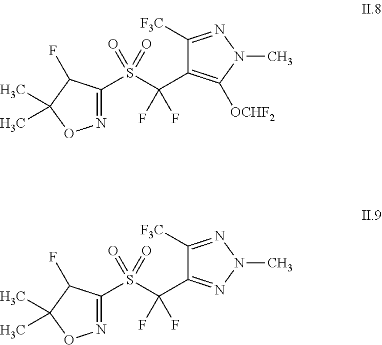

the isoxazoline compounds of the formula (I)I are known in the art, e.g. from WO 2006/024820, WO 2006/037945, WO 2007/071900 and WO 2007/096576;
among the VLCFA inhibitors, preference is given to chloroacetamides and oxyacetamides;
   c11) from the group of the cellulose biosynthesis inhibitors:
   chlorthiamid, dichlobenil, flupoxam, isoxaben and 1-Cyclohexyl-5-pentafluorphenyloxy-1⁴-[1,2,4,6]thiatriazin-3-ylamine;
   c12) from the group of the decoupler herbicides:
   dinoseb, dinoterb and DNOC and its salts;
   c13) from the group of the auxinic herbicides:
   2,4-D and its salts and esters such as clacyfos, 2,4-DB and its salts and esters, aminocyclopyrachlor and its salts and esters, aminopyralid and its salts such as aminopyralid-tris(2-hydroxypropyl)ammonium and its esters, benazolin, benazolin-ethyl, chloramben and its salts and esters, clomeprop, clopyralid and its salts and esters, dicamba and its salts and esters, dichlorprop and its salts and esters, dichlorprop-P and its salts and esters, fluroxypyr, fluroxypyr-butometyl, fluroxypyr-meptyl, halauxifen and its salts and esters (CAS 943832-60-8); MCPA and its salts and esters, MCPA-thioethyl, MCPB and its salts and esters, mecoprop and its salts and esters, mecoprop-P and its salts and esters, picloram and its salts and esters, quinclorac, quinmerac, TBA (2,3,6) and its salts and esters and triclopyr and its salts and esters;
   c14) from the group of the auxin transport inhibitors: diflufenzopyr, diflufenzopyr-sodium, naptalam and naptalam-sodium;
   c15) from the group of the other herbicides: bromobutide, chlorflurenol, chlorflurenol-methyl, cinmethylin, cumyluron, cyclopyrimorate (CAS 499223-49-3) and its salts and esters, dalapon, dazomet, difenzoquat, difenzoquat-metilsulfate, dimethipin, DSMA, dymron, endothal and its salts, etobenzanid, flamprop, flamprop-isopropyl, flamprop-methyl, flamprop-M-isopropyl, flamprop-M-methyl, flurenol, flurenol-butyl, flurprimidol, fosamine, fosamine-ammonium, indanofan, indaziflam, maleic hydrazide, mefluidide, metam, methiozolin (CAS 403640-27-7), methyl azide, methyl bromide, methyl-dymron, methyl iodide, MSMA, oleic acid, oxaziclomefone, pelargonic acid, pyributicarb, quinoclamine, triaziflam and tridiphane.

Preferred herbicides C that can be used in combination with the compositions according to the present invention are:

c1) from the group of the lipid biosynthesis inhibitors:
clethodim, clodinafop-propargyl, cycloxydim, cyhalofop-butyl, diclofop-methyl, fenoxaprop-P-ethyl, fluazifop-P-butyl, haloxyfop-P-methyl, metamifop, pinoxaden, profoxydim, propaquizafop, quizalofop-P-ethyl, quizalofop-P-tefuryl, sethoxydim, tepraloxydim, tralkoxydim, 4-(4′-Chloro-4-cyclopropyl-2′-fluoro[1,1′-biphenyl]-3-yl)-5-hydroxy-2,2,6,6-tetramethyl-2H-pyran-3(6H)-one (CAS 1312337-72-6); 4-(2′,4′-Dichloro-4-cyclopropyl[1,1′-biphenyl]-3-yl)-5-hydroxy-2,2,6,6-tetramethyl-2H-pyran-3(6H)-one (CAS 1312337-45-3); 4-(4′-Chloro-4-ethyl-2′-fluoro[1,1′-biphenyl]-3-yl)-5-hydroxy-2,2,6,6-tetramethyl-2H-pyran-3(6H)-one (CAS 1033757-93-5); 4-(2′,4′-Dichloro-4-ethyl[1,1′-biphenyl]-3-yl)-2,2,6,6-tetramethyl-2H-pyran-3,5(4H,6H)-dione (CAS 1312340-84-3); 5-(Acetyloxy)-4-(4′-chloro-4-cyclopropyl-2′-fluoro[1,1′-biphenyl]-3-yl)-3,6-dihydro-2,2,6,6-tetramethyl-2H-pyran-3-one (CAS 1312337-48-6); 5-(Acetyloxy)-4-(2′,4′-dichloro-4-cyclopropyl-[1,1′-biphenyl]-3-yl)-3,6-dihydro-2,2,6,6-tetramethyl-2H-pyran-3-one; 5-(Acetyloxy)-4-(4′-chloro-4-ethyl-2′-fluoro[1,1′-biphenyl]-3-yl)-3,6-dihydro-2,2,6,6-tetramethyl-2H-pyran-3-one (CAS 1312340-82-1); 5-(Acetyloxy)-4-(2′,4′-dichloro-4-ethyl[1,1′-biphenyl]-3-yl)-3,6-dihydro-2,2,6,6-tetramethyl-2H-pyran-3-one (CAS 1033760-55-2); 4-(4′-Chloro-4-cyclopropyl-2′-fluoro[1,1′-biphenyl]-3-yl)-5,6-dihydro-2,2,6,6-tetramethyl-5-oxo-2H-pyran-3-yl carbonic acid methyl ester (CAS 1312337-51-1); 4-(2′,4′-Dichloro-4-cyclopropyl-[1,1′-biphenyl]-3-yl)-5,6-dihydro-2,2,6,6-tetramethyl-5-oxo-2H-pyran-3-yl carbonic acid methyl ester; 4-(4′-Chloro-4-ethyl-2′-fluoro[1,1′-biphenyl]-3-yl)-5,6-dihydro-2,2,6,6-tetramethyl-5-oxo-2H-pyran-3-yl carbonic acid methyl ester (CAS 1312340-83-2); 4-(2′,4′-Dichloro-4-ethyl[1,1′-biphenyl]-3-yl)-5,6-dihydro-2,2,6,6-tetramethyl-5-oxo-2H-pyran-3-yl carbonic acid methyl ester (CAS 1033760-58-5); benfuresate, dimepiperate, EPTC, esprocarb, ethofumesate, molinate, orbencarb, prosulfocarb, thiobencarb and triallate;
c2) from the group of the ALS inhibitors:
amidosulfuron, azimsulfuron, bensulfuron-methyl, bispyribac-sodium, chlorimuron-ethyl, chlorsulfuron, cloransulam-methyl, cyclosulfamuron, diclosulam, ethametsulfuron-methyl, ethoxysulfuron, flazasulfuron, florasulam, flucarbazone-sodium, flucetosulfuron, flumetsulam, flupyrsulfuron-methyl-sodium, foramsulfuron, halosulfuron-methyl, imazamethabenz-methyl, imazamox, imazapic, imazapyr, imazaquin, imazethapyr, imazosulfuron, iodosulfuron, iodosulfuron-methyl-sodium, iofensulfuron, iofensulfuron-sodium, mesosulfuron, metazosulfuron, metosulam, metsulfuron-methyl, nicosulfuron, orthosulfamuron, oxasulfuron, penoxsulam, primisulfuron-methyl, propoxycarbazon-sodium, propyrisulfuron, prosulfuron, pyrazosulfuron-ethyl, pyribenzoxim, pyrimisulfan, pyriftalid, pyriminobac-methyl, pyrithiobac-sodium, pyroxsulam, rimsulfuron, sulfometuron-methyl, sulfosulfuron, thiencarbazone-methyl, thifensulfuron-methyl, triasulfuron, tribenuron-methyl, trifloxysulfuron, triflusulfuron-methyl, tritosulfuron and triafamone;
c3) from the group of the photosynthesis inhibitors:
ametryn, amicarbazone, atrazine, bentazone, bentazone-sodium, bromoxynil and its salts and esters, chloridazone, chlorotoluron, cyanazine, desmedipham, diquat-dibromide, diuron, fluometuron, hexazinone, ioxynil and its salts and esters, isoproturon, lenacil, linuron, metamitron, methabenzthiazuron, metribuzin, paraquat, paraquat-dichloride, phenmedipham, propanil, pyridate, simazine, terbutryn, terbuthylazine and thidiazuron;
c4) from the group of the protoporphyrinogen-IX oxidase inhibitors:
acifluorfen-sodium, bencarbazone, benzfendizone, butafenacil, carfentrazone-ethyl, cinidon-ethyl, flufenpyr-ethyl, flumiclorac-pentyl, flumioxazin, fluoroglycofen-ethyl, fomesafen, lactofen, oxadiargyl, oxadiazon, oxyfluorfen, pentoxazone, pyraflufen-ethyl, saflufenacil, sulfentrazone, ethyl[3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate (CAS 353292-31-6; S-3100), N-ethyl-3-(2,6-dichloro-4-trifluoromethylphenoxy)-5-methyl-1H-pyrazole-1-carboxamide (CAS 452098-92-9), N-tetrahydrofurfuryl-3-(2,6-dichloro-4-trifluoromethylphenoxy)-5-methyl-1H-pyrazole-1-carboxamide (CAS 915396-43-9), N-ethyl-3-(2-chloro-6-fluoro-4-trifluoromethylphenoxy)-5-methyl-1H-pyrazole-1-carboxamide (CAS 452099-05-7), N-tetrahydrofurfuryl-3-(2-chloro-6-fluoro-4-trifluoromethylphenoxy)-5-methyl-1H-pyrazole-1-carboxamide (CAS 452100-03-7), 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione, 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione (CAS 1258836-72-4), 2-(2,2,7-Trifluoro-3-oxo-4-prop-2-ynyl-3,4-dihydro-2H-benzo[1,4]oxazin-6-yl)-4,5,6,7-tetrahydro-isoindole-1,3-dione, 1-Methyl-6-trifluoromethyl-3-(2,2,7-trifluoro-3-oxo-4-prop-2-ynyl-3,4-dihydro-2H-benzo[1,4]oxazin-6-yl)-1H-pyrimidine-2,4-dione, and 3-[7-Chloro-5-fluoro-2-(trifluoromethyl)-1H-benzimidazol-4-yl]-1-methyl-6-(trifluoromethyl)-1H-pyrimidine-2,4-dione (CAS 212754-02-4);
c5) from the group of the bleacher herbicides:
aclonifen, beflubutamid, benzobicyclon, clomazone, diflufenican, flurochloridone, flurtamone, isoxaflutole, mesotrione, norflurazon, picolinafen, pyrasulfotole, pyrazolynate, sulcotrione, tefuryltrione, tembotrione, topramezone, bicyclopyrone, 4-(3-trifluoromethylphenoxy)-2-(4-trifluoromethylphenyl)pyrimidine (CAS 180608-33-7), amitrole and flumeturon;
c6) from the group of the EPSP synthase inhibitors:
glyphosate, glyphosate-isopropylammonium, glyphosate-potassium and glyphosate-trimesium (sulfosate);
c7) from the group of the glutamine synthase inhibitors:
glufosinate, glufosinate-P, glufosinate-ammonium;
c8) from the group of the DHP synthase inhibitors: asulam;
c9) from the group of the mitosis inhibitors:
benfluralin, dithiopyr, ethalfluralin, oryzalin, pendimethalin, thiazopyr and trifluralin;
c10) from the group of the VLCFA inhibitors:
acetochlor, alachlor, anilofos, butachlor, cafenstrole, dimethenamid, dimethenamid-P, fentrazamide, flufenacet, mefenacet, metazachlor, metolachlor, S-metolachlor, naproanilide, napropamide, pretilachlor, fenoxasulfone, ipfencarbazone, pyroxasulfone thenylchlor and isoxazoline-compounds of the formulae II.1, II.2, II.3, II.4, II.5, II.6, II.7, II.8 and II.9 as mentioned above;
c11) from the group of the cellulose biosynthesis inhibitors: dichlobenil, flupoxam, isoxaben and 1-Cyclohexyl-5-pentafluorphenyloxy-1⁴-[1,2,4,6]thiatriazin-3-ylamine;
c13) from the group of the auxinic herbicides:
2,4-D and its salts and esters, aminocyclopyrachlor and its salts and esters, aminopyralid and its salts such as aminopyralid-tris(2-hydroxypropyl)ammonium and its esters, clopyralid and its salts and esters, dicamba and its salts and esters, dichlorprop-P and its salts and esters, fluroxypyr-meptyl, halauxifen and its salts and esters (CAS 943832-60-8), MCPA and its salts and esters, MCPB and its salts and esters, mecoprop-P and its salts and esters, picloram and its salts and esters, quinclorac, quinmerac and triclopyr and its salts and esters;
c14) from the group of the auxin transport inhibitors: diflufenzopyr and diflufenzopyr-sodium;
c15) from the group of the other herbicides: bromobutide, cinmethylin, cumyluron, cyclopyrimorate (CAS 499223-49-3) and its salts and esters, dalapon, difenzoquat, difenzoquat-metilsulfate, DSMA, dymron (=daimuron), flamprop, flamprop-isopropyl, flamprop-methyl, flamprop-M-isopropyl, flamprop-M-methyl, indanofan, indaziflam, metam, methylbromide, MSMA, oxaziclomefone, pyributicarb, triaziflam and tridiphane.

Particularly preferred herbicides C that can be used in combination with the compositions according to the present invention are:

c1) from the group of the lipid biosynthesis inhibitors: clodinafop-propargyl, cycloxydim, cyhalofop-butyl, fenoxaprop-P-ethyl, pinoxaden, profoxydim, tepraloxydim, tralkoxydim, 4-(4′-Chloro-4-cyclopropyl-2′-fluoro[1,1′-biphenyl]-3-yl)-5-hydroxy-2,2,6,6-tetramethyl-2H-pyran-3(6H)-one (CAS 1312337-72-6); 4-(2′,4′-Dichloro-4-cyclopropyl[1,1′-biphenyl]-3-yl)-5-hydroxy-2,2,6,6-tetramethyl-2H-pyran-3(6H)-one (CAS 1312337-45-3); 4-(4′-Chloro-4-ethyl-2′-fluoro[1,1′-biphenyl]-3-yl)-5-hydroxy-2,2,6,6-tetramethyl-2H-pyran-3(6H)-one (CAS 1033757-93-5); 4-(2′,4′-Dichloro-4-ethyl[1,1′-biphenyl]-3-yl)-2,2,6,6-tetramethyl-2H-pyran-3,5(4H,6H)-dione (CAS 1312340-84-3); 5-(Acetyloxy)-4-(4′-chloro-4-cyclopropyl-2′-fluoro[1,1′-biphenyl]-3-yl)-3,6-dihydro-2,2,6,6-tetramethyl-2H-pyran-3-one (CAS 1312337-48-6); 5-(Acetyloxy)-4-(2′,4′-dichloro-4-cyclopropyl-[1,1′-biphenyl]-3-yl)-3,6-dihydro-2,2,6,6-tetramethyl-2H-pyran-3-one; 5-(Acetyloxy)-4-(4′-chloro-4-ethyl-2′-fluoro[1,1′-biphenyl]-3-yl)-3,6-dihydro-2,2,6,6-tetramethyl-2H-pyran-3-one (CAS 1312340-82-1); 5-(Acetyloxy)-4-(2′,4′-dichloro-4-ethyl[1,1′-biphenyl]-3-yl)-3,6-dihydro-2,2,6,6-tetramethyl-2H-pyran-3-one (CAS 1033760-55-2); 4-(4′-Chloro-4-cyclopropyl-2′-fluoro[1,1′-biphenyl]-3-yl)-5,6-dihydro-2,2,6,6-tetramethyl-5-oxo-2H-pyran-3-yl carbonic acid methyl ester (CAS 1312337-51-1); 4-(2′,4′-Dichloro-4-cyclopropyl-[1,1′-biphenyl]-3-yl)-5,6-dihydro-2,2,6,6-tetramethyl-5-oxo-2H-pyran-3-yl carbonic acid methyl ester; 4-(4′-Chloro-4-ethyl-2′-fluoro[1, 1′-biphenyl]-3-yl)-5,6-dihydro-2,2,6,6-tetramethyl-5-oxo-2H-pyran-3-yl carbonic acid methyl ester (CAS 1312340-83-2); 4-(2′,4′-Dichloro-4-ethyl[1,1′-biphenyl]-3-yl)-5,6-dihydro-2,2,6,6-tetramethyl-5-oxo-2H-pyran-3-yl carbonic acid methyl ester (CAS 1033760-58-5); esprocarb, prosulfocarb, thiobencarb and triallate;
c2) from the group of the ALS inhibitors: bensulfuron-methyl, bispyribac-sodium, cyclosulfamuron, diclosulam, flumetsulam, flupyrsulfuron-methyl-sodium, foramsulfuron, imazamox, imazapic, imazapyr, imazaquin, imazethapyr, imazosulfuron, iodosulfuron, iodosulfuron-methyl-sodium, iofensulfuron, iofensulfuron-sodium, mesosulfuron, metazosulfuron, nicosulfuron, penoxsulam, propoxycarbazon-sodium, propyrisulfuron, pyrazosulfuron-ethyl, pyroxsulam, rimsulfuron, sulfosulfuron, thiencarbazon-methyl, tritosulfuron and triafamone;
c3) from the group of the photosynthesis inhibitors: ametryn, atrazine, diuron, fluometuron, hexazinone, isoproturon, linuron, metribuzin, paraquat, paraquat-dichloride, propanil, terbutryn and terbuthylazine;
c4) from the group of the protoporphyrinogen-IX oxidase inhibitors: flumioxazin, oxyfluorfen, saflufenacil, sulfentrazone, ethyl[3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate (CAS 353292-31-6), 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione, 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione (CAS 1258836-72-4, and 2-(2,2,7-Trifluoro-3-oxo-4-prop-2-ynyl-3,4-dihydro-2H-benzo[1,4]oxazin-6-yl)-4,5,6,7-tetrahydro-isoindole-1,3-dione, and 1-Methyl-6-trifluoromethyl-3-(2,2,7-trifluoro-3-oxo-4-prop-2-ynyl-3,4-dihydro-2H-benzo[1,4]oxazin-6-yl)-1H-pyrimidine-2,4-dione;
c5) from the group of the bleacher herbicides: clomazone, diflufenican, flurochloridone, isoxaflutole, mesotrione, picolinafen, sulcotrione, tefuryltrione, tembotrione, topramezone, bicyclopyrone, amitrole and flumeturon;
c6) from the group of the EPSP synthase inhibitors: glyphosate, glyphosate-isopropylammonium and glyphosate-trimesium (sulfosate);
c7) from the group of the glutamine synthase inhibitors: glufosinate, glufosinate-P and glufosinate-ammonium;
c9) from the group of the mitosis inhibitors: pendimethalin and trifluralin;
c10) from the group of the VLCFA inhibitors: acetochlor, cafenstrole, dimethenamid-P, fentrazamide, flufenacet, mefenacet, metazachlor, metolachlor, S-metolachlor, fenoxasulfone, ipfencarbazone and pyroxasulfone; likewise, preference is given to isoxazoline compounds of the formulae II.1, II.2, II.3, II.4, II.5, II.6, II.7, II.8 and II.9 as mentioned above;
c11) from the group of the cellulose biosynthesis inhibitors: isoxaben;
c13) from the group of the auxinic herbicides: 2,4-D and its salts and esters such as clacyfos, and aminocyclopyrachlor and its salts and esters, aminopyralid and its salts and its esters, clopyralid and its salts and esters, dicamba and its salts and esters, fluroxypyr-meptyl, quinclorac and quinmerac;
c14) from the group of the auxin transport inhibitors: diflufenzopyr and diflufenzopyr-sodium,
c15) from the group of the other herbicides: dymron (=daimuron), indanofan, indaziflam, oxaziclomefone and triaziflam.

In another embodiment of the present invention the compositions comprise at least one safener D.

Safeners are chemical compounds which prevent or reduce damage on useful plants without having a major impact on the herbicidal action of the herbicidal active components of the present compositions towards unwanted plants. They can be applied either before sowings (e.g. on seed treatments, shoots or seedlings) or in the pre-emergence application or post-emergence application of the useful plant. The safeners and the compositions according to the present invention can be applied simultaneously or in succession.

Examples of preferred safeners D are benoxacor, cloquintocet, cyometrinil, cyprosulfamide, dichlormid, dicyclonon, dietholate, fenchlorazole, fenclorim, flurazole, fluxofenim, furilazole, isoxadifen, mefenpyr, mephenate, naphthalic anhydride, oxabetrinil, 4-(dichloroacetyl)-1-oxa-4-azaspiro[4.5]decane (MON4660, CAS 71526-07-3), 2,2,5-trimethyl-3-(dichloroacetyl)-1,3-oxazolidine (R-29148, CAS 52836-31-4) and N-(2-Methoxybenzoyl)-4-[(methylaminocarbonyl)amino]benzenesulfonamide (CAS 129531-12-0).

Especially preferred safeners D are benoxacor, cloquintocet, cyprosulfamide, dichlormid, fenchlorazole, fenclorim, flurazole, fluxofenim, furilazole, isoxadifen, mefenpyr, naphthalic anhydride, oxabetrinil, 4-(dichloroacetyl)-1-oxa-4-azaspiro[4.5]decane (MON4660, CAS 71526-07-3), 2,2,5-trimethyl-3-(dichloroacetyl)-1,3-oxazolidine (R-29148, CAS 52836-31-4) and N-(2-Methoxybenzoyl)-4-[(methylaminocarbonyl)amino]benzenesulfonamide (CAS 129531-12-0).

Particularly preferred safeners D are benoxacor, cloquintocet, cyprosulfamide, dichlormid, fenchlorazole, fenclorim, furilazole, isoxadifen, mefenpyr, naphtalic anhydride, 4-(dichloroacetyl)-1-oxa-4-azaspiro[4.5]decane (MON4660, CAS 71526-07-3), 2,2,5-trimethyl-3-(dichloroacetyl)-1,3-oxazolidine (R-29148, CAS 52836-31-4) and N-(2-Methoxybenzoyl)-4-[(methylaminocarbonyl)amino]benzenesulfonamide (CAS 129531-12-0).

The herbicides (B) and C and the safeners D are known compounds, see, for example, The Compendium of Pesticide Common Names (http://www.alanwood.net/pesticides/); Farm Chemicals Handbook 2000 volume 86, Meister Publishing Company, 2000; B. Hock, C. Fedtke, R. R. Schmidt, Herbizide [Herbicides], Georg Thieme Verlag, Stuttgart 1995; W. H. Ahrens, Herbicide Handbook, 7th edition, Weed Science Society of America, 1994; and K. K. Hatzios, Herbicide Handbook, Supplement for the 7th edition, Weed Science Society of America, 1998. 2,2,5-Trimethyl-3-(dichloroacetyl)-1,3-oxazolidine [CAS No. 52836-31-4] is also referred to as R-29148. 4-(Dichloroacetyl)-1-oxa-4-azaspiro[4.5]decane [CAS No. 71526-07-3] is also referred to as AD-67 and MON 4660.

The assignment of the active compounds to the respective mechanisms of action is based on current knowledge. If several mechanisms of action apply to one active compound, this substance was only assigned to one mechanism of action.

Compounds (B), C and D having a carboxyl group can be employed in the form of the acid, in the form of an agriculturally suitable salt as mentioned above or else in the form of an agriculturally useful derivative in the compositions according to the invention.

In the case of dicamba, suitable salts include those, where the counterion is an agriculturally acceptable cation. For example, suitable salts of dicamba are dicamba-sodium, dicamba-potassium, dicamba-methylammonium, dicamba-dimethylammonium, dicamba-isopropylammonium, dicamba-diglycolamine, dicamba-olamine, dicamba-diolamine, dicamba-trolamine, dicamba-N,N-bis-(3-aminopropyl)methylamine and dicamba-diethylenetriamine. Examples of a suitable ester are dicamba-methyl and dicamba-butotyl.

Suitable salts of 2,4-D are 2,4-D-ammonium, 2,4-D-dimethylammonium, 2,4-D-diethylammonium, 2,4-D-diethanolammonium (2,4-D-diolamine), 2,4-D-triethanolammonium, 2,4-D-isopropylammonium, 2,4-D-triisopropanolammonium, 2,4-D-heptylammonium, 2,4-D-dodecylammonium, 2,4-D-tetradecylammonium, 2,4-D-triethylammonium, 2,4-D-tris(2-hydroxypropyl)ammonium, 2,4-D-tris(isopropyl)ammonium, 2,4-D-trolamine, 2,4-D-lithium, 2,4-D-sodium. Examples of suitable esters of 2,4-D are 2,4-D-butotyl, 2,4-D-2-butoxypropyl, 2,4-D-3-butoxypropyl, 2,4-D-butyl, 2,4-D-ethyl, 2,4-D-ethylhexyl, 2,4-D-isobutyl, 2,4-D-isooctyl, 2,4-D-isopropyl, 2,4-D-meptyl, 2,4-D-methyl, 2,4-D-octyl, 2,4-D-pentyl, 2,4-D-propyl, 2,4-D-tefuryl and clacyfos.

Suitable salts of 2,4-DB are for example 2,4-DB-sodium, 2,4-DB-potassium and 2,4-DB-dimethylammonium. Suitable esters of 2,4-DB are for example 2,4-DB-butyl and 2,4-DB-isoctyl. Suitable salts of dichlorprop are for example dichlorprop-sodium, dichlorprop-potassium and dichlorprop-dimethylammonium. Examples of suitable esters of dichlorprop are dichlorprop-butotyl and dichlorprop-isoctyl.

Suitable salts and esters of MCPA include MCPA-butotyl, MCPA-butyl, MCPA-dimethylammonium, MCPA-diolamine, MCPA-ethyl, MCPA-thioethyl, MCPA-2-ethylhexyl, MCPA-isobutyl, MCPA-isoctyl, MCPA-isopropyl, MCPA-isopropylammonium, MCPA-methyl, MCPA-olamine, MCPA-potassium, MCPA-sodium and MCPA-trolamine.

A suitable salt of MCPB is MCPB sodium. A suitable ester of MCPB is MCPB-ethyl.

Suitable salts of clopyralid are clopyralid-potassium, clopyralid-olamine and clopyralid-tris-(2-hydroxypropyl)ammonium. Example of suitable esters of clopyralid is clopyralid-methyl. Examples of a suitable ester of fluroxypyr are fluroxypyr-meptyl and fluroxypyr-2-butoxy-1-methylethyl, wherein fluroxypyr-meptyl is preferred.

Suitable salts of picloram are picloram-dimethylammonium, picloram-potassium, picloram-triisopropanolammonium, picloram-triisopropylammonium and picloram-trolamine. A suitable ester of picloram is picloram-isoctyl.

A suitable salt of triclopyr is triclopyr-triethylammonium. Suitable esters of triclopyr are for example triclopyr-ethyl and triclopyr-butotyl.

Suitable salts and esters of chloramben include chloramben-ammonium, chloramben-diolamine, chloramben-methyl, chloramben-methylammonium and chloramben-sodium. Suitable salts and esters of 2,3,6-TBA include 2,3,6-TBA-dimethylammonium, 2,3,6-TBA-lithium, 2,3,6-TBA-potassium and 2,3,6-TBA-sodium.

Suitable salts and esters of aminopyralid include aminopyralid-potassium and aminopyralid-tris(2-hydroxypropyl)ammonium.

Suitable salts of glyphosate are for example glyphosate-ammonium, glyphosate-diammonium, glyphoste-dimethylammonium, glyphosate-isopropylammonium, glyphosate-potassium, glyphosate-sodium, glyphosate-trimesium as well as the ethanolamine and diethanolamine salts, preferably glyphosate-diammonium, glyphosate-isopropylammonium and glyphosate-trimesium (sulfosate).

A suitable salt of glufosinate is for example glufosinate-ammonium.

A suitable salt of glufosinate-P is for example glufosinate-P-ammonium.

Suitable salts and esters of bromoxynil are for example bromoxynil-butyrate, bromoxynil-heptanoate, bromoxynil-octanoate, bromoxynil-potassium and bromoxynil-sodium.

Suitable salts and esters of ioxonil are for example ioxonil-octanoate, ioxonil-potassium and ioxonil-sodium.

Suitable salts and esters of mecoprop include mecoprop-butotyl, mecoprop-dimethylammonium, mecoprop-diolamine, mecoprop-ethadyl, mecoprop-2-ethylhexyl, mecoprop-isoctyl, mecoprop-methyl, mecoprop-potassium, mecoprop-sodium and mecoprop-trolamine.

Suitable salts of mecoprop-P are for example mecoprop-P-butotyl, mecoprop-P-dimethylammonium, mecoprop-P-2-ethylhexyl, mecoprop-P-isobutyl, mecoprop-P-potassium and mecoprop-P-sodium.

A suitable salt of diflufenzopyr is for example diflufenzopyr-sodium.

A suitable salt of naptalam is for example naptalam-sodium.

Suitable salts and esters of aminocyclopyrachlor are for example aminocyclopyrachlor-dimethylammonium, aminocyclopyrachlor-methyl, aminocyclopyrachlor-triisopropanolammonium, aminocyclopyrachlor-sodium and aminocyclopyrachlor-potassium.

A suitable salt of quinclorac is for example quinclorac-dimethylammonium.

A suitable salt of quinmerac is for example quinclorac-dimethylammonium.

A suitable salt of imazamox is for example imazamox-ammonium.

Suitable salts of imazapic are for example imazapic-ammonium and imazapic-isopropylammonium.

Suitable salts of imazapyr are for example imazapyr-ammonium and imazapyr-isopropylammonium.

A suitable salt of imazaquin is for example imazaquin-ammonium.

Suitable salts of imazethapyr are for example imazethapyr-ammonium and imazethapyr-isopropylammonium.

A suitable salt of topramezone is for example topramezone-sodium.

According to a preferred embodiment of the invention, the composition comprises as anionic herbicide (B) at least one, preferably exactly one anionic herbicide (B).

According to another preferred embodiment of the invention, the composition comprises as anionic herbicide (B) at least two, preferably exactly two anionic herbicides (B) different from each other.

According to another preferred embodiment of the invention, the composition comprises as anionic herbicide (B) at least three, preferably exactly three anionic herbicides (B) different from each other.

According to a preferred embodiment of the invention, the composition comprises as anionic herbicide (B) at least one, preferably exactly one anionic herbicide (B) and exactly one herbicide C.

According to another preferred embodiment of the invention, the composition comprises as anionic herbicide (B) at least two, preferably exactly two anionic herbicides (B) different from each other and exactly one herbicide C.

According to another preferred embodiment of the invention, the composition comprises as anionic herbicide (B) at least three, preferably exactly three anionic herbicides (B) different from each other and exactly one herbicide C.

According to another preferred embodiment of the invention, the composition comprises as safener D at least one, preferably exactly one safener D.

The invention also relates to agrochemical compositions comprising an auxiliary and at least one composition according to the invention.

An agrochemical composition comprises a pesticidal effective amount of at least one composition according to the invention. The term “effective amount” denotes an amount of the active ingredients, which is sufficient for controlling unwanted plants, especially for controlling unwanted plants in cultivated plants and which does not result in a substantial damage to the treated plants. Such an amount can vary in a broad range and is dependent on various factors, such as the plants to be controlled, the treated cultivated plant or material, the climatic conditions and the specific composition according to the invention used.

The compositions according to the invention can be converted into customary types of agrochemical compositions, e.g. solutions, emulsions, suspensions, dusts, powders, pastes, granules, pressings, capsules, and mixtures thereof. Examples for agrochemical composition types are suspensions (e.g. SC, OD, FS), emulsifiable concentrates (e.g. EC), emulsions (e.g. EW, EO, ES, ME), capsules (e.g. CS, ZC), pastes, pastilles, wettable powders or dusts (e.g. WP, SP, WS, DP, DS), pressings (e.g. BR, TB, DT), granules (e.g. WG, SG, GR, FG, GG, MG), insecticidal articles (e.g. LN), as well as gel formulations for the treatment of plant propagation materials such as seeds (e.g. GF). These and further agrochemical compositions types are defined in the “Catalogue of pesticide formulation types and international coding system”, Technical Monograph No. 2, 6^{th} Ed. May 2008, CropLife International.

The agrochemical compositions are prepared in a known manner, such as described by Mollet and Grubemann, Formulation technology, Wiley VCH, Weinheim, 2001; or Knowles, New developments in crop protection product formulation, Agrow Reports DS243, T&F Informa, London, 2005.

Suitable auxiliaries are solvents, liquid carriers, solid carriers or fillers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers and binders.

Suitable solvents and liquid carriers are water and organic solvents, such as mineral oil fractions of medium to high boiling point, e.g. kerosene, diesel oil; oils of vegetable or animal origin; aliphatic, cyclic and aromatic hydrocarbons, e.g. toluene, paraffin, tetrahydronaphthalene, alkylated naphthalenes; alcohols, e.g. ethanol, propanol, butanol, benzylalcohol, cyclohexanol; glycols; DMSO; ketones, e.g. cyclohexanone; esters, e.g. lactates, carbonates, fatty acid esters, gamma-butyrolactone; fatty acids; phosphonates; amines; amides, e.g. N-methylpyrrolidone, fatty acid dimethylamides; and mixtures thereof.

Suitable solid carriers or fillers are mineral earths, e.g. silicates, silica gels, talc, kaolins, limestone, lime, chalk, clays, dolomite, diatomaceous earth, bentonite, calcium sulfate, magnesium sulfate, magnesium oxide; polysaccharides, e.g. cellulose, starch; fertilizers, e.g. ammonium sulfate, ammonium phosphate, ammonium nitrate, ureas; products of vegetable origin, e.g. cereal meal, tree bark meal, wood meal, nutshell meal, and mixtures thereof.

Suitable surfactants are surface-active compounds, such as anionic, cationic, nonionic and amphoteric surfactants, block polymers, polyelectrolytes, and mixtures thereof. Such surfactants can be used as emusifier, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters.

Examples of carboxylates are alkyl carboxylates, and carboxylated alcohol or alkylphenol ethoxylates.

Suitable nonionic surfactants are alkoxylates, N-subsituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B—C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.

Suitable adjuvants are compounds, which have a neglectable or even no pesticidal activity themselves, and which improve the biological performance of the compositions on the target. Examples are surfactants, mineral or vegetable oils, and other auxilaries. Further examples are listed by Knowles, Adjuvants and additives, Agrow Reports DS256, T&F Informa UK, 2006, chapter 5.

Suitable thickeners are polysaccharides (e.g. xanthan gum, carboxymethylcellulose), anorganic clays (organically modified or unmodified), polycarboxylates, and silicates.

Suitable bactericides are bronopol and isothiazolinone derivatives such as alkylisothiazolinones and benzisothiazolinones.

Suitable anti-freezing agents are ethylene glycol, propylene glycol, urea and glycerin.

Suitable anti-foaming agents are silicones, long chain alcohols, and salts of fatty acids.

Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants).

Suitable tackifiers or binders are polyvinylpyrrolidons, polyvinylacetates, polyvinyl alcohols, polyacrylates, biological or synthetic waxes, and cellulose ethers.

Examples for agrochemical composition types and their preparation are:
i) Water-soluble concentrates (SL, LS)
10-60 wt % of a composition according to the invention and 5-15 wt % wetting agent (e.g. alcohol alkoxylates) are dissolved in water and/or in a water-soluble solvent (e.g. alcohols) ad 100 wt %. The active substance dissolves upon dilution with water.
ii) Dispersible concentrates (DC)
5-25 wt % of a composition according to the invention and 1-10 wt % dispersant (e.g. polyvinylpyrrolidone) are dissolved in organic solvent (e.g. cyclohexanone) ad 100 wt %. Dilution with water gives a dispersion.
iii) Emulsifiable concentrates (EC)
15-70 wt % of a composition according to the invention and 5-10 wt % emulsifiers (e.g. calcium dodecylbenzenesulfonate and castor oil ethoxylate) are dissolved in water-insoluble organic solvent (e.g. aromatic hydrocarbon) ad 100 wt %. Dilution with water gives an emulsion.
iv) Emulsions (EW, EO, ES)
5-40 wt % of a composition according to the invention and 1-10 wt % emulsifiers (e.g. calcium dodecylbenzenesulfonate and castor oil ethoxylate) are dissolved in 20-40 wt % water-insoluble organic solvent (e.g. aromatic hydrocarbon). This mixture is introduced into water ad 100 wt % by means of an emulsifying machine and made into a homogeneous emulsion. Dilution with water gives an emulsion.
v) Suspensions (SC, OD, FS)
In an agitated ball mill, 20-60 wt % of a composition according to the invention are comminuted with addition of 2-10 wt % dispersants and wetting agents (e.g. sodium lignosulfonate and alcohol ethoxylate), 0,1-2 wt % thickener (e.g. xanthan gum) and water ad 100 wt % to give a fine active substance suspension. Dilution with water gives a stable suspension of the active substance. For FS type composition up to 40 wt % binder (e.g. polyvinylalcohol) is added.
vi) Water-dispersible granules and water-soluble granules (WG, SG)
50-80 wt % of a composition according to the invention are ground finely with addition of dispersants and wetting agents (e.g. sodium lignosulfonate and alcohol ethoxylate) ad 100 wt % and prepared as water-dispersible or water-soluble granules by means of technical appliances (e.g. extrusion, spray tower, fluidized bed). Dilution with water gives a stable dispersion or solution of the active substance.
vii) Water-dispersible powders and water-soluble powders (WP, SP, WS)
50-80 wt % of a composition according to the invention are ground in a rotor-stator mill with addition of 1-5 wt % dispersants (e.g. sodium lignosulfonate), 1-3 wt % wetting agents (e.g. alcohol ethoxylate) and solid carrier (e.g. silica gel) ad 100 wt %. Dilution with water gives a stable dispersion or solution of the active substance.
viii) Gel (GW, GF)
In an agitated ball mill, 5-25 wt % of a composition according to the invention are comminuted with addition of 3-10 wt % dispersants (e.g. sodium lignosulfonate), 1-5 wt % thickener (e.g. carboxymethylcellulose) and water ad 100 wt % to give a fine suspension of the active substance. Dilution with water gives a stable suspension of the active substance.
iv) Microemulsion (ME)
5-20 wt % of a composition according to the invention are added to 5-30 wt % organic solvent blend (e.g. fatty acid dimethylamide and cyclohexanone), 10-25 wt % surfactant blend (e.g. alcohol ethoxylate and arylphenol ethoxylate), and water ad 100%. This mixture is stirred for 1 h to produce spontaneously a thermodynamically stable microemulsion.
iv) Microcapsules (CS)
   An oil phase comprising 5-50 wt % of a composition according to the invention, 0-40 wt % water insoluble organic solvent (e.g. aromatic hydrocarbon), 2-15 wt % acrylic monomers (e.g. methylmethacrylate, methacrylic acid and a di- or triacrylate) are dispersed into an aqueous solution of a protective colloid (e.g. polyvinyl alcohol). Radical polymerization initiated by a radical initiator results in the formation of poly(meth)acrylate microcapsules. Alternatively, an oil phase comprising 5-50 wt % of a composition according to the invention, 0-40 wt % water insoluble organic solvent (e.g. aromatic hydrocarbon), and an isocyanate monomer (e.g. diphenylmethene-4,4′-diisocyanatae) are dispersed into an aqueous solution of a protective colloid (e.g. polyvinyl alcohol). The addition of a polyamine (e.g. hexamethylenediamine) results in the formation of a polyurea microcapsules. The monomers amount to 1-10 wt %. The wt % relate to the total CS composition.
ix) Dustable powders (DP, DS)
1-10 wt % of a composition according to the invention are ground finely and mixed intimately with solid carrier (e.g. finely divided kaolin) ad 100 wt %.
x) Granules (GR, FG)
0.5-30 wt % of a composition according to the invention is ground finely and associated with solid carrier (e.g. silicate) ad 100 wt %. Granulation is achieved by extrusion, spray-drying or the fluidized bed.
xi) Ultra-low volume liquids (UL)
1-50 wt % of a composition according to the invention are dissolved in organic solvent (e.g. aromatic hydrocarbon) ad 100 wt %.
The agrochemical compositions types i) to xi) may optionally comprise further auxiliaries, such as 0,1-1 wt % bactericides, 5-15 wt % anti-freezing agents, 0,1-1 wt % anti-foaming agents, and 0,1-1 wt % colorants.
The agrochemical compositions generally comprise between 0.01 and 95%, preferably between 0.1 and 90%, and in particular between 0.5 and 75%, by weight of active substance.

The active substances are employed in a purity of from 90% to 100%, preferably from 95% to 100% (according to NMR spectrum).

Solutions for seed treatment (LS), suspoemulsions (SE), flowable concentrates (FS), powders for dry treatment (DS), water-dispersible powders for slurry treatment (WS), water-soluble powders (SS), emulsions (ES), emulsifiable concentrates (EC) and gels (GF) are usually employed for the purposes of treatment of plant propagation materials, particularly seeds. The compositions in question give, after two-to-tenfold dilution, active substance concentrations of from 0.01 to 60% by weight, preferably from 0.1 to 40% by weight, in the ready-to-use preparations. Application can be carried out before or during sowing.

Methods for applying the compositions according to the invention to plant propagation material, especially seeds include dressing, coating, pelleting, dusting, soaking and in-furrow application methods of the propagation material. Preferably, the compositions, respectively, are applied on to the plant propagation material by a method such that germination is not induced, e.g. by seed dressing, pelleting, coating and dusting.

Various types of oils, wetters, adjuvants, fertilizer, or micronutrients, and further pesticides (e.g. herbicides, insecticides, fungicides, growth regulators, safeners) may be added to the compositions comprising them as premix or, if appropriate not until immediately prior to use (tank mix). These agents can be admixed with the compositions according to the invention in a weight ratio of 1:100 to 100:1, preferably 1:10 to 10:1.

The user applies the agrochemical composition according to the invention usually from a predosage device, a knapsack sprayer, a spray tank, a spray plane, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2000 liters, preferably 50 to 400 liters, of the ready-to-use spray liquor are applied per hectare of agricultural useful area.

According to one embodiment, either individual components of the agrochemical composition according to the invention or partially premixed components, e.g. the aminocarboxylate (A) and the anionic herbicide (B) and optionally a herbicide C may be mixed by the user in a spray tank and further auxiliaries and additives may be added, if appropriate.
In a further embodiment, individual components of the agrochemical composition according to the invention such as parts of a kit or parts of a binary or ternary mixture may be mixed by the user himself in a spray tank and further auxiliaries may be added, if appropriate.
In a further embodiment, either individual components of the agrochemical composition according to the invention or partially premixed components, e.g. the aminocarboxylate (A) and the anionic herbicide (B) and optionally a herbicide C, can be applied jointly (e.g. after tank mix) or consecutively.

Accordingly, a first embodiment of the invention relates to compositions in the form of a agrochemical composition formulated as a 1-component composition comprising the aminocarboxylate (A), the anionic herbicide (B), optionally a further herbicide C and also a solid or liquid carrier and, if appropriate, one or more surfactants.

Accordingly, a second embodiment of the invention relates to compositions in the form of a agrochemical composition formulated as a 2-component composition comprising a first formulation (component) comprising the aminocarboxylate (A), a solid or liquid carrier and, if appropriate, one or more surfactants, and a second component comprising the anionic herbicide (B), optionally a further herbicide C, a solid or liquid carrier and, if appropriate, one or more surfactants.

The components (A), (B), and optionally C and D can be formulated and applied jointly or separately, simultaneously or in succession, before, during or after the emergence of the plants.

In case of separate application, the order of the application of the active compounds (A), (B) and optionally C and D is of minor importance.

The compositions according to the invention are suitable as herbicides. They are suitable as such or as an appropriately formulated composition (agrochemical composition).

The compositions according to the invention control vegetation on non-crop areas very efficiently, especially at high rates of application. They act against broad-leafed weeds and grass weeds in crops such as wheat, rice, corn, soybeans and cotton without causing any significant damage to the crop plants. This effect is mainly observed at low rates of application.

The compositions according to the invention are applied to the plants mainly by spraying the leaves. Here, the application can be carried out using, for example, water as carrier by customary spraying techniques using spray liquor amounts of from about 100 to 1000 l/ha (for example from 300 to 400 l/ha). The herbicidal compositions may also be applied by the low-volume or the ultra-low-volume method, or in the form of microgranules.

Application of the herbicidal compositions according to the present invention can be done before, during and/or after, preferably during and/or after, the emergence of the undesirable plants.

The herbicidal compositions according to the present invention can be applied pre- or post-emergence or together with the seed of a crop plant. It is also possible to apply the compounds and compositions by applying seed, pretreated with a composition of the invention, of a crop plant. If the active compounds A and B and, if appropriate C, are less well tolerated by certain crop plants, application techniques may be used in which the herbicidal compositions are sprayed, with the aid of the spraying equipment, in such a way that as far as possible they do not come into contact with the leaves of the sensitive crop plants, while the active compounds reach the leaves of undesirable plants growing underneath, or the bare soil surface (post-directed, lay-by).

In a further embodiment, the composition according to the invention can be applied by treating seed. The treatment of seed comprises essentially all procedures familiar to the person skilled in the art (seed dressing, seed coating, seed dusting, seed soaking, seed film coating, seed multilayer coating, seed encrusting, seed dripping and seed pelleting) based on the compounds of the formula (I) according to the invention or the compositions prepared therefrom. Here, the herbicidal compositions can be applied diluted or undiluted.

The term “seed” comprises seed of all types, such as, for example, corns, seeds, fruits, tubers, seedlings and similar forms. Here, preferably, the term seed describes corns and seeds. The seed used can be seed of the useful plants mentioned above, but also the seed of transgenic plants or plants obtained by customary breeding methods.

Moreover, it may be advantageous to apply the compositions of the present invention on their own or jointly in combination with other crop protection agents, for example with agents for controlling pests or phytopathogenic fungi or bacteria or with groups of active compounds which regulate growth. Also of interest is the miscibility with mineral salt solutions which are employed for treating nutritional and trace element deficiencies. Non-phytotoxic oils and oil concentrates can also be added.
In the context of the present invention, the application rate of the herbicidal active compounds (B) and optionally C is, depending on the kind of effect desired, from 0.001 to 2 kg per ha, preferably from 0.005 to 2 kg per ha, more preferably from 0.05 to 0.9 kg per ha and in particular from 0.1 to 0.75 kg per ha.
The required application rates of safeners D are generally in the range of from 0.0005 kg/ha to 2.5 kg/ha and preferably in the range of from 0.005 kg/ha to 2 kg/ha or 0.01 kg/ha to 1.5 kg/h of a.s.

In treatment of plant propagation materials such as seeds, e.g. by dusting, coating or drenching seed, amounts of active substance of from 0.1 to 1000 g, preferably from 1 to 1000 g, more preferably from 1 to 100 g and most preferably from 5 to 100 g, per 100 kilogram of plant propagation material (preferably seeds) are generally required.
In another embodiment of the invention, to treat the seed, the amounts of active substances applied are generally employed in amounts of from 0.001 to 10 kg per 100 kg of seed.
When used in the protection of materials or stored products, the amount of active substance applied depends on the kind of application area and on the desired effect. Amounts customarily applied in the protection of materials are 0.001 g to 2 kg, preferably 0.005 g to 1 kg, of active substance per cubic meter of treated material.

Depending on the application method in question, the compositions according to the invention can additionally be employed in a further number of crop plants for eliminating undesirable plants. Examples of suitable crops are the following:

Allium cepa, Ananas comosus, Arachis hypogaea, Asparagus officinalis, Avena sativa, Beta vulgaris spec. altissima, Beta vulgaris spec. rapa, Brassica napus var. napus, Brassica napus var. napobrassica, Brassica rapa var. silvestris, Brassica oleracea, Brassica nigra, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N. rustica), Olea europaea, Oryza sativa, Phaseolus luntus, Phaseolus vulgaris, Picea abies, Pinus spec., Pistacia vera, Pisum sativum, Prunus avium, Prunus persica, Pyrus communis, Prunus armeniaca, Prunus cerasus, Prunus dulcis and prunus domestica, Ribes sylvestre, Ricinus communis, Saccharum officinarum, Secale cereale, Sinapis alba, Solanum tuberosum, Sorghum bicolor (s. vulgare), Theobroma cacao, Trifolium pratense, Triticum aestivum, Triticale, Triticum durum, Vicia faba, Vitis vinifera, Zea mays.

Preferred crops are Arachis hypogaea, Beta vulgaris spec. altissima, Brassica napus var. napus, Brassica oleracea, Citrus limon, Citrus sinensis, Coffea arabica (Coffea canephora, Coffea liberica), Cynodon dactylon, Glycine max, Gossypium hirsutum, (Gossypium arboreum, Gossypium herbaceum, Gossypium vitifolium), Helianthus annuus, Hordeum vulgare, Juglans regia, Lens culinaris, Linum usitatissimum, Lycopersicon lycopersicum, Malus spec., Medicago sativa, Nicotiana tabacum (N. rustica), Olea europaea, Oryza sativa, Phaseolus lunatus, Phaseolus vulgaris, Pistacia vera, Pisum sativum, Prunus dulcis, Saccharum officinarum, Secale cereale, Solanum tuberosum, Sorghum bicolor (s. vulgare), Triticale, Triticum aestivum, Triticum durum, Vicia faba, Vitis vinifera and Zea mays

Especially preferred crops are crops of cereals, corn, soybeans, rice, oilseed rape, cotton, potatoes, peanuts or permanent crops.

The compositions according to the invention can also be used in genetically modified plants. The term “genetically modified plants” is to be understood as plants whose genetic material has been modified by the use of recombinant DNA techniques to include an inserted sequence of DNA that is not native to that plant species' genome or to exhibit a deletion of DNA that was native to that species' genome, wherein the modification(s) cannot readily be obtained by cross breeding, mutagenesis or natural recombination alone. Often, a particular genetically modified plant will be one that has obtained its genetic modification(s) by inheritance through a natural breeding or propagation process from an ancestral plant whose genome was the one directly treated by use of a recombinant DNA technique. Typically, one or more genes have been integrated into the genetic material of a genetically modified plant in order to improve certain properties of the plant. Such genetic modifications also include but are not limited to targeted post-translational modification of protein(s), oligo- or polypeptides. e.g., by inclusion therein of amino acid mutation(s) that permit, decrease, or promote glycosylation or polymer additions such as prenylation, acetylation farnesylation, or PEG moiety attachment.

Plants that have been modified by breeding, mutagenesis or genetic engineering, e.g. have been rendered tolerant to applications of specific classes of herbicides, such as auxinic herbicides such as dicamba or 2,4-D; bleacher herbicides such as 4-hydroxyphenylpyruvate dioxygenase (HPPD) inhibitors or phytoene desaturase (PDS) inhibitors; acetolactate synthase (ALS) inhibitors such as sulfonylureas or imidazolinones; enolpyruvyl shikimate 3-phosphate synthase (EPSP) inhibitors such as glyphosate; glutamine synthetase (GS) inhibitors such as glufosinate; protoporphyrinogen-IX oxidase inhibitors; lipid biosynthesis inhibitors such as acetylCoA carboxylase (ACCase) inhibitors; or oxynil (i.e. bromoxynil or ioxynil) herbicides as a result of conventional methods of breeding or genetic engineering; furthermore, plants have been made resistant to multiple classes of herbicides through multiple genetic modifications, such as resistance to both glyphosate and glufosinate or to both glyphosate and a herbicide from another class such as ALS inhibitors, HPPD inhibitors, auxinic herbicides, or ACCase inhibitors. These herbicide resistance technologies are, for example, described in Pest Management Science 61, 2005, 246; 61, 2005, 258; 61, 2005, 277; 61, 2005, 269; 61, 2005, 286; 64, 2008, 326; 64, 2008, 332; Weed Science 57, 2009, 108; Australian Journal of Agricultural Research 58, 2007, 708; Science 316, 2007, 1185; and references quoted therein. Several cultivated plants have been rendered tolerant to herbicides by mutgenesis and conventional methods of breeding, e.g., Clearfield® summer rape (Canola, BASF SE, Germany) being tolerant to imidazolinones, e.g., imazamox, or ExpressSun® sunflowers (DuPont, USA) being tolerant to sulfonyl ureas, e.g., tribenuron. Genetic engineering methods have been used to render cultivated plants such as soybean, cotton, corn, beets and rape, tolerant to herbicides such as glyphosate, imidazolinones and glufosinate, some of which are under development or commercially available under the brands or trade names RoundupReady® (glyphosate tolerant, Monsanto, USA), Cultivance® (imidazolinone tolerant, BASF SE, Germany) and LibertyLink® (glufosinate tolerant, Bayer CropScience, Germany).

Furthermore, plants are also covered that are by the use of recombinant DNA techniques capable to synthesize one or more insecticidal proteins, especially those known from the bacterial genus Bacillus, particularly from Bacillus thuringiensis, such as delta-endotoxins, e.g., CryIA(b), CryIA(c), CryIF, CryIF(a2), CryIIA(b), CryIIIA, CryIIIB(b1) or Cry9c; vegetative insecticidal proteins (VIP), e.g., VIP1, VIP2, VIP3 or VIP3A; insecticidal proteins of bacteria colonizing nematodes, e.g., Photorhabdus spp. or Xenorhabdus spp.; toxins produced by animals, such as scorpion toxins, arachnid toxins, wasp toxins, or other insect-specific neurotoxins; toxins produced by fungi, such as Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxy-steroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilbene synthase, bibenzyl synthase, chitinases or glucanases. In the context of the present invention these insecticidal proteins or toxins are to be understood expressly also as including pre-toxins, hybrid proteins, truncated or otherwise modified proteins. Hybrid proteins are characterized by a new combination of protein domains, (see, e.g., WO 02/015701). Further examples of such toxins or genetically modified plants capable of synthesizing such toxins are disclosed, e.g., in EP-A 374 753, WO 93/007278, WO 95/34656, EP-A 427 529, EP-A 451 878, WO 03/18810 und WO 03/52073. The methods for producing such genetically modified plants are generally known to the person skilled in the art and are described, e.g., in the publications mentioned above. These insecticidal proteins contained in the genetically modified plants impart to the plants producing these proteins tolerance to harmful pests from all taxonomic groups of arthropods, especially to beetles (Coleoptera), two-winged insects (Diptera), and moths (Lepidoptera) and to nematodes (Nematoda). Genetically modified plants capable to synthesize one or more insecticidal proteins are, e.g., described in the publications mentioned above, and some of which are commercially available such as YieldGard® (corn cultivars producing the Cry1Ab toxin), YieldGard® Plus (corn cultivars producing Cry1Ab and Cry3Bb1 toxins), Starlink® (corn cultivars producing the Cry9c toxin), Herculex® RW (corn cultivars producing Cry34Ab1, Cry35Ab1 and the enzyme Phosphinothricin-N-Acetyltransferase [PAT]); NuCOTN® 33B (cotton cultivars producing the Cry1Ac toxin), Bollgard® I (cotton cultivars producing the Cry1Ac toxin), Bollgard® II (cotton cultivars producing Cry1Ac and Cry2Ab2 toxins); VIPCOT® (cotton cultivars producing a VIP-toxin); NewLeaf® (potato cultivars producing the Cry3A toxin); Bt-Xtra®, NatureGard®, KnockOut®, BiteGard®, Protecta®, Bt11 (e.g., Agrisure® CB) and Bt176 from Syngenta Seeds SAS, France, (corn cultivars producing the Cry1Ab toxin and PAT enzyme), MIR604 from Syngenta Seeds SAS, France (corn cultivars producing a modified version of the Cry3A toxin, c.f. WO 03/018810), MON 863 from Monsanto Europe S.A., Belgium (corn cultivars producing the Cry3Bb1 toxin), IPC 531 from Monsanto Europe S.A., Belgium (cotton cultivars producing a modified version of the Cry1Ac toxin) and 1507 from Pioneer Overseas Corporation, Belgium (corn cultivars producing the Cry1F toxin and PAT enzyme).

Furthermore, plants are also covered that are by the use of recombinant DNA techniques capable to synthesize one or more proteins to increase the resistance or tolerance of those plants to bacterial, viral or fungal pathogens. Examples of such proteins are the so-called “pathogenesis-related proteins” (PR proteins, see, e.g., EP-A 392 225), plant disease resistance genes (e.g., potato culti-vars, which express resistance genes acting against Phytophthora infestans derived from the Mexican wild potato, Solanum bulbocastanum) or T4-lyso-zym (e.g., potato cultivars capable of synthesizing these proteins with increased resistance against bacteria such as Erwinia amylovora). The methods for producing such genetically modified plants are generally known to the person skilled in the art and are described, e.g., in the publications mentioned above.

Furthermore, plants are also covered that are by the use of recombinant DNA techniques capable to synthesize one or more proteins to increase the productivity (e.g., bio-mass production, grain yield, starch content, oil content or protein content), tolerance to drought, salinity or other growth-limiting environmental factors or tolerance to pests and fungal, bacterial or viral pathogens of those plants.

Furthermore, plants are also covered that contain by the use of recombinant DNA techniques a modified amount of ingredients or new ingredients, specifically to improve human or animal nutrition, e.g., oil crops that produce health-promoting long-chain omega-3 fatty acids or unsaturated omega-9 fatty acids (e.g., Nexera® rape, Dow AgroSciences, Canada).

Furthermore, plants are also covered that contain by the use of recombinant DNA techniques a modified amount of ingredients or new ingredients, specifically to improve raw material production, e.g., potatoes that produce increased amounts of amylopectin (e.g. Amflora® potato, BASF SE, Germany).

Furthermore, it has been found that the compositions according to the invention are also suitable for the defoliation and/or desiccation of plant parts, for which crop plants such as cotton, potato, oilseed rape, sunflower, soybean or field beans, in particular cotton, are suitable. In this regard compositions have been found for the desiccation and/or defoliation of plants, processes for preparing these compositions, and methods for desiccating and/or defoliating plants using the compositions according to the invention.

As desiccants, the compositions according to the invention are suitable in particular for desiccating the above-ground parts of crop plants such as potato, oilseed rape, sunflower and soybean, but also cereals. This makes possible the fully mechanical harvesting of these important crop plants.

Also of economic interest is the facilitation of harvesting, which is made possible by concentrating within a certain period of time the dehiscence, or reduction of adhesion to the tree, in citrus fruit, olives and other species and varieties of pomaceous fruit, stone fruit and nuts. The same mechanism, i.e. the promotion of the development of abscission tissue between fruit part or leaf part and shoot part of the plants is also essential for the controlled defoliation of useful plants, in particular cotton.

Moreover, a shortening of the time interval in which the individual cotton plants mature leads to an increased fiber quality after harvesting.

The herbicidal action of the compositions according to the invention was demonstrated by the following greenhouse experiments:

The culture containers used were plastic pots containing loamy sand with approximately 3.0% of humus as substrate. The seeds of the test plants were sown separately for each species.

For the pre-emergence treatment, the compositions, suspended or emulsified in water, were applied directly after sowing by means of finely distributing nozzles. The containers were irrigated gently to promote germination and growth and subsequently covered with transparent plastic hoods until the plants had rooted. This cover caused uniform germination of the test plants unless this was adversely affected by the active compounds.

For the post-emergence treatment, the test plants were grown to a plant height of from 3 to 15 cm, depending on the plant habit, and only then treated with the compositions, which had been suspended or emulsified in water. To this end, the test plants were either sown and grown in the same containers, or they were first grown separately as seedlings and transplanted into the test containers a few days prior to treatment.

Depending on the species, the plants were kept at 10-25° C. and 20-35° C., respectively.

The test period extended over 2 to 4 weeks. During this time, the plants were tended and their response to the individual treatments was evaluated.

Evaluation was carried out using a scale from 0 to 100. 100 means no emergence of the plants, or complete destruction of at least the above-ground parts, and 0 means no damage or normal course of growth. A good herbicidal activity is given at values of at least 70, and very good herbicidal activity is given at values of at least 85.

The plants used in the greenhouse experiments were of the following species:

| Bayer code | Scientific name |
|---|---|
| SETVE | Setaria verticillata |
| TRFRE | Trifolium repens |
| TAROF | Taraxacum officinale |
| ZEAMX | Zea mays |
| TRZAW | Triticum aestivum; winter wheat |
| GLXMA | Glycine max |

### USE EXAMPLE 1

improved efficacy of anionic herbicides (B) under hard water conditions;

| anionic herbicide (B) | surfactant | sequestrant | water hardness [ppm] |
|---|---|---|---|
| glyphosate | Genamin T150 | MGDA-Na₃ | 500 |
| (acid equivalent) | 300 g/ha | 160 g/ha | |
| 140 g/ha | | | |

| phytotoxicity in % | ZEAMX | TRZAW | GLXMA | SETVE | TRFRE | TAROF |
|---|---|---|---|---|---|---|
| | 80 | 88 | 57 | 99 | 18 | 85 |

### USE EXAMPLE 2

Hard Water Antagonism—Dicamba+MGDA; evaluation 21 days after treatment

| | | | ABUTH |
|---|---|---|---|
| Treatment | Water | Rate (g ae/ha) | % control |
| Dicamba + NIS | Distilled | 210 + 0.25% v/v | 54 |
| Dicamba + NIS | Hard | 210 + 0.25% v/v | 39 |
| Dicamba + | Hard | 210 + 140 + | 46 |
| K3-MGDA + NIS | | 0.25% v/v | |
| Dicamba + | Hard | 210 + 280 + | 49 |
| K3-MGDA + NIS | | 0.25% v/v | |
| Dicamba + | Hard | 210 + 560 + | 50 |
| K3-MGDA + NIS | | 0.25% v/v | |
| Dicamba + | Hard | 210 + 1120 + | 51 |
| K3-MGDA + NIS | | 0.25% v/v | |
| LSD (0.05) | | | 8 |

Hard water was created by adding MgCl₂•6H₂O and CaCl₂•H₂O to distilled water.
Hard water = 1000 ppm of CaCO₃;
Ca²⁺ = 323 ppm,
Mg²⁺ = 49 ppm
ABUTH—Abutilon theophrasi
NIS—nonionic surfactant

### USE EXAMPLE 3

Hard Water Antagonism—Glyphosate+MGDA; evaluation 26 days after treatment

| | | | SORHA |
|---|---|---|---|
| Treatment | Water | Rate (g ae/ha) | % control |
| Glyphosate + NIS | Distilled | 420 + 0.25% v/v | 59 |
| Glyphosate + NIS | Hard | 420 + 0.25% v/v | 9 |
| Glyphosate + | Hard | 420 + 47 + | 19 |
| K3-MGDA + NIS | | 0.25% v/v | |
| Glyphosate + | Hard | 420 + 94 + | 11 |
| K3-MGDA + NIS | | 0.25% v/v | |
| Glyphosate + | Hard | 420 + 187 + | 53 |
| K3-MGDA + NIS | | 0.25% v/v | |
| Glyphosate + | Hard | 420 + 375 + | 74 |
| K3-MGDA + NIS | | 0.25% v/v | |
| Glyphosate + | Hard | 420 + 748 + | 99 |
| K3-MGDA + NIS | | 0.25% v/v | |
| Glyphosate + | Hard | 420 + 47 + | 39 |
| Na3-MGDA + NIS | | 0.25% v/v | |
| Glyphosate + | Hard | 420 + 94 + | 24 |
| Na3-MGDA + NIS | | 0.25% v/v | |
| Glyphosate + | Hard | 420 + 187 + | 70 |
| Na3-MGDA + NIS | | 0.25% v/v | |
| Glyphosate + | Hard | 420 + 375 + | 100 |
| Na3-MGDA + NIS | | 0.25% v/v | |
| Glyphosate + | Hard | 420 + 748 + | 91 |
| Na3-MGDA + NIS | | 0.25% v/v | |
| LSD (0.05) | | | 28 |

Hard water was created by adding MgCl₂•6H₂O and CaCl₂•H₂O to distilled water.
Hard water = 680 ppm of CaCO₃;
Ca²⁺ = 201 ppm,
Mg²⁺ = 43 ppm
SORHA—Sorghum halepense
NIS—nonionic surfactant

### USE EXAMPLE 4

Hard Water Antagonism—Glyphosate+MGDA; evaluation 21 days after treatment

| | | | ECHCG |
|---|---|---|---|
| Treatment | Water | Rate (g ae/ha) | % control |
| Glyphosate + NIS | Distilled | 420 + 0.25% v/v | 87 |
| Glyphosate + NIS | Hard | 420 + 0.25% v/v | 40 |
| Glyphosate + | Hard | 420 + 44 + | 42 |
| K3-MGDA + NIS | | 0.25% v/v | |
| Glyphosate + | Hard | 420 + 88 + | 77 |
| K3-MGDA + NIS | | 0.25% v/v | |
| Glyphosate + | Hard | 420 + 177 + | 77 |
| K3-MGDA + NIS | | 0.25% v/v | |
| Glyphosate + | Hard | 420 + 265 + | 82 |
| K3-MGDA + NIS | | 0.25% v/v | |
| Glyphosate + | Hard | 420 + 353 + | 90 |
| K3-MGDA + NIS | | 0.25% v/v | |
| Glyphosate + | Hard | 420 + 707 + | 90 |
| K3-MGDA + NIS | | 0.25% v/v | |
| LSD (0.05) | | | 16 |

Hard water was created by adding MgCl₂•6H₂O and CaCl₂•H₂O to distilled water.
Hard water = 1000 ppm of CaCO₃;
Ca²⁺ = 323 ppm,
Mg²⁺ = 49 ppm
ECHCG—Echinochloa crus-galli
NIS—nonionic surfactant

### USE EXAMPLE 5

Hard Water Antagonism—Glyphosate+MGDA; evaluation 29 days after treatment

| | | | ABUTH | IPOHG |
|---|---|---|---|---|
| Treatment | Water | Rate (g ae/ha) | - % control - | |
| Glyphosate + NIS | Distilled | 560 + 0.25% v/v | 87 | 67 |
| Glyphosate + NIS | Hard | 560 + 0.25% v/v | 40 | 37 |
| Glyphosate + | Hard | 560 + 336 + | 70 | 60 |
| K3-MGDA + NIS | | 0.25% v/v | | |
| Glyphosate + | Hard | 560 + 673 + | 73 | 60 |
| K3-MGDA + NIS | | 0.25% v/v | | |
| Glyphosate + | Hard | 560 + 1346 + | 83 | 63 |
| K3-MGDA + NIS | | 0.25% v/v | | |
| LSD (0.05) | | | 23 | 18 |

Hard water was created by adding MgCl₂•6H₂O and CaCl₂•H₂O to distilled water.
Hard water = 1000 ppm of CaCO₃;
Ca²⁺ = 323 ppm,
Mg²⁺ = 49 ppm
ABUTH—Abutilon theophrasti;
IPOHG—Ipomea hederacea
NIS—nonionic surfactant

### COMPARATIVE EXAMPLE

Hard Water Antagonism Glufosinate+MGDA vs. Glufosinate+EDTA; evaluation 15 days after treatment

| | | | CHEAL |
|---|---|---|---|
| Treatment | Water | Rate (g ae/ha) | % control |
| Glufosinate + NIS | Distilled | 280 + 0.25% v/v | 59 |
| Glufosinate + NIS | Hard | 280 + 0.25% v/v | 26 |
| Glufosinate + | Hard | 280 + 187 + | 44 |
| MGDA + NIS | | 0.25% v/v | |
| Glufosinate + | Hard | 280 + 560 + | 54 |
| MGDA + NIS | | 0.25% v/v | |
| Glufosinate + | Hard | 280 + 187 + | 6 |
| EDTA + NIS | | 0.25% v/v | |
| Glufosinate + | Hard | 280 + 560 + | 7 |
| EDTA + NIS | | 0.25% v/v | |
| LSD (0.05) | | | 24 |

Hard water was created by adding MgCl₂•6H₂O and CaCl₂•H₂O to distilled water.
Hard water = 1000 ppm of CaCO₃;
Ca²⁺ = 323 ppm,
Mg²⁺ = 49 ppm
CHEAL—Chenopodium album
MGDA formulated as potassium salt (K3-MGDA)
EDTA formulated as BAPMA salt (BAPMA-EDTA)
NIS—nonionic surfactant

1-27. (canceled)

28. A method for improving the efficacy of anionic herbicides (B) under hard water conditions, comprising the steps of:
a) providing at least one anionic herbicide (B) and at least one aminocarboxylate (A), selected from the group consisting of methylglycine diacetate (MGDA; A1), glutamic acid diacetate (GLDA; A2), iminodisuccinate (IDS; A3), N-(2-hydroxyethyl)imino diacetate (HEIDA; A4), ethylenediamine-N,N′-disuccinate (EDDS; A5) and their salts;
b) diluting components (A) and (B) with water, wherein the concentration of dissolved calcium, magnesium, iron and aluminum salts in said water is more than 120 ppm; and
c) applying the diluted mixture to the area to be treated.

29. The method of claim 28, wherein the aminocarboxylate (A) is selected from the group consisting of methylglycine diacetate (A1), glutamic acid diacetate (A2) and their salts.

30. The method of claim 28, wherein the aminocarboxylate (A) is selected from the group consisting of iminodisuccinate (A3), N-(2-hydroxyethyl)imino diacetate (A4), ethylenediamine-N,N′-disuccinate (A5) and their salts.

31. The method of claim 28, wherein the aminocarboxylate (A) is methylglycine diacetate trisodium salt or methylglycine diacetate tripotassium salt.

32. The method of claim 28, wherein the concentration of dissolved calcium, magnesium, iron and aluminum salts in said water is more than 180 ppm.

33. The method of claim 28, wherein the concentration of dissolved calcium, magnesium, iron and aluminum salts in said water is more than 300 ppm.

34. The method of claim 28, wherein the anionic herbicide (B) is selected from the groups (B1) to (B5):
(B1) aromatic acid herbicides selected from the group consisting of diflufenzopyr, naptalam, chloramben, dicamba, 2,3,6-trichlorobenzoic acid (2,3,6-TBA), tricamba, bispyribac, pyriminobac, pyrithiobac, chlorthal, aminopyralid, clopyralid, halauxifen, picloram, quinclorac, quinmerac, and aminocyclopyrachlor;
(B2) phenoxycarboxylic acid herbicides selected from the group consisting of 4-chlorophenoxyacetic acid (4-CPA), (2,4-dichlorophenoxy)acetic acid (2,4-D), (3,4-dichlorophenoxy)acetic acid (3,4-DA), MCPA (4-(4-chloro-o-tolyloxy)butyric acid), MCPA-thioethyl, (2,4,5-trichlorophenoxy)acetic acid (2,4,5-T), 4-CPB, 4-(2,4-dichlorophenoxy)butyric acid (2,4-DB), 4-(3,4-dichlorophenoxy)butyric acid (3,4-DB), 4-(4-chloro-o-tolyloxy)butyric acid (MCPB), 4-(2,4,5-trichlorophenoxy)butyric acid (2,4,5-TB), cloprop, 2-(4-chlorophenoxy)propanoic acid (4-CPP), dichlorprop, dichlorprop-P, 4-(3,4-dichlorophenoxy)butyric acid (3,4-DP), fenoprop, mecoprop, mecoprop-P, chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, metamifop, propaquizafop, quizalofop, quizalofop-P, and trifop;
(B3) organophosphorus herbicides comprising a carboxylic acid group selected from the group consisting of bialafos, glufosinate, glufosinate-P, and glyphosate;
(B4) other herbicides comprising a carboxylic acid selected from the group consisting of fluroxypyr, triclopyr, cloransulam, bensulfuron, chlorimuron, foramsulfuron, halosulfuron, mesosulfuron, primisulfuron, sulfometuron, imazamethabenz, imazamethabenz, imazamox, imazapic, imazapyr, imazaquin, imazethapyr, flucarbazone, propoxycarbazone, thiencarbazone, acifluorfen, bifenox, carfentrazone, flufenpyr, flumiclorac, fluoroglycofen, fluthiacet, lactofen, pyraflufen, chlorflurenol, dalapon, endothal, flamprop, flamprop-M, flupropanate, flurenol, oleic acid, and pelargonic acid;
(B5) other herbicides that are weak acids, selected from the group consisting of topramezone, tefuryltrione, pyrasulfotole, sulcotrione, fenquinotrione, bicyclopyrone, mesotrione, tembotrione, saflufenacil, fomesafen, halosafen, 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione (CAS 1258836-72-4), clethodim, sethoxydim, cycloxydim, profoxydim, tepraloxydim, tralkoxydim, amidosulfuron, azimsulfuron, bensulfuron, bensulfuron-methyl, chlorimuron, chlorimuron-ethyl, chlorsulfuron, cinosulfuron, cyclosulfamuron, ethametsulfuron, ethametsulfuron-methyl, ethoxysulfuron, flazasulfuron, flucetosulfuron, flupyrsulfuron, flupyrsulfuron-methyl, foramsulfuron, halosulfuron, halosulfuron-methyl, imazosulfuron, iodosulfuron, iodosulfuron-methyl, iofensulfuron, mesosulfuron, metazosulfuron, metsulfuron, metsulfuronmethyl, nicosulfuron, orthosulfamuron, oxasulfuron, primisulfuron, primisulfuron-methyl, propyrisulfuron, prosulfuron, pyrazosulfuron, pyrazosulfuron-ethyl, rimsulfuron, sulfometuron, sulfometuron-methyl, sulfosulfuron, thifensulfuron, thifensulfuron-methyl, triasulfuron, tribenuron, tribenuron-methyl, trifloxysulfuron, triflusulfuron, triflusulfuron-methyl, tritosulfuron, and bentazone;
and their agriculturally useful derivatives.

35. The method of claim 28, wherein the anionic herbicide (B) is selected from the group consisting of dicamba, 2,4-D, quizalofop, quizalofop-P, glufosinate, glufosinate-P, glyphosate, sethoxydim, clethodim and their agriculturally useful derivatives.

36. The method of claim 28, wherein the anionic herbicide (B) is selected from dicamba and its agriculturally useful derivatives.

37. The method of claim 28, wherein the concentration of dissolved calcium, magnesium, iron and aluminum salts in said water is more than 300 ppm.

38. A composition comprising
a) one or more aminocarboxylate (A), selected from the group consisting of methylglycine diacetate (MGDA; A1), glutamic acid diacetate (GLDA; A2), iminodisuccinate (IDS; A3), N-(2-hydroxyethyl)imino diacetate (HEIDA; A4), ethylenediamine-N,N′-disuccinate (EDDS; A5) and their salts, wherein aminocarboxylates (A) are not complexed with a transition metal; and
b) at least one anionic herbicide (B);
except compositions comprising exactly one herbicidal compound, which is selected from the group consisting of organic phosphates, organic phosphonates, organic phosphites and their respective salts; and
except compositions comprising as aminocarboxylate (A) ethylenediamine-N,N′-disuccinate (EDDS; A5) and/or its salts and as anionic herbicide (B) exactly one herbicidal compound, which is selected from the group of water soluble selective auxin-type herbicides consisting of aminopyralid, clopyralid, 2,4-D, dicamba, dichlorprop, fluroxypyr, MCPA, mecoprop, picloram, quinclorac, quinmerac, triclopyr and their agriculturally useful derivatives; and
except compositions comprising as aminocarboxylate (A) ethylenediamine-N,N′-disuccinate (EDDS; A5) and/or its salts and as anionic herbicide (B) a combination of 2,4-D, dicamba and mecoprop and/or agriculturally useful derivatives.

39. The composition of claim 38, wherein the aminocarboxylate (A) is selected from the group consisting of methylglycine diacetate (A1), glutamic acid diacetate (A2) and their salts.

40. The composition of claim 38, wherein the aminocarboxylate (A) is selected from the group consisting of iminodisuccinate (A3), N-(2-hydroxyethyl)imino diacetate (A4), ethylenediamine-N,N′-disuccinate (A5) and their salts.

41. The composition of claim 38, wherein the aminocarboxylate (A) is selected from the group consisting of iminodisuccinate (A3) and its salts.

42. The composition of claim 38, wherein the anionic herbicide (B) is selected from the groups (B1), (B2), (B4) and (B5):
(B1) aromatic acid herbicides selected from the group consisting of diflufenzopyr, naptalam, chloramben, dicamba, 2,3,6-trichlorobenzoic acid (2,3,6-TBA), tricamba, bispyribac, pyriminobac, pyrithiobac, chlorthal, aminopyralid, clopyralid, halauxifen, picloram, quinclorac, quinmerac, or aminocyclopyrachlor;
(B2) phenoxycarboxylic acid herbicides selected from the group consisting of 4-chlorophenoxyacetic acid (4-CPA), (2,4-dichlorophenoxy)acetic acid (2,4-D), (3,4-dichlorophenoxy)acetic acid (3,4-DA), MCPA (4-(4-chloro-o-tolyloxy)butyric acid), MCPA-thioethyl, (2,4,5-trichlorophenoxy)acetic acid (2,4,5-T), 4-CPB, 4-(2,4-dichlorophenoxy)butyric acid (2,4-DB), 4-(3,4-dichlorophenoxy)butyric acid (3,4-DB), 4-(4-chloro-o-tolyloxy)butyric acid (MCPB), 4-(2,4,5-trichlorophenoxy)butyric acid (2,4,5-TB), cloprop, 2-(4-chlorophenoxy)propanoic acid (4-CPP), dichlorprop, dichlorprop-P, 4-(3,4-dichlorophenoxy)butyric acid (3,4-DP), fenoprop, mecoprop, mecoprop-P, chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, metamifop, propaquizafop, quizalofop, quizalofop-P, trifop;
(B3) organophosphorus herbicides comprising a carboxylic acid group selected from the group consisting of bialafos, glufosinate, glufosinate-P, glyphosate;
(B4) other herbicides comprising a carboxylic acid selected from the group consisting of fluroxypyr, triclopyr, cloransulam, bensulfuron, chlorimuron, foramsulfuron, halosulfuron, mesosulfuron, primisulfuron, sulfometuron, imazamethabenz, imazamethabenz, imazamox, imazapic, imazapyr, imazaquin, imazethapyr, flucarbazone, propoxycarbazone, thiencarbazone, acifluorfen, bifenox, carfentrazone, flufenpyr, flumiclorac, fluoroglycofen, fluthiacet, lactofen, pyraflufen, chlorflurenol, dalapon, endothal, flamprop, flamprop-M, flupropanate, flurenol, oleic acid, pelargonic acid;
(B5) other herbicides that are weak acids, selected from the group consisting of topramezone, tefuryltrione, pyrasulfotole, sulcotrione, fenquinotrione, bicyclopyrone, mesotrione, tembotrione, saflufenacil, fomesafen, halosafen, 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione (CAS 1258836-72-4), clethodim, sethoxydim, cycloxydim, profoxydim, tepraloxydim, tralkoxydim, amidosulfuron, azimsulfuron, bensulfuron, bensulfuron-methyl, chlorimuron, chlorimuron-ethyl, chlorsulfuron, cinosulfuron, cyclosulfamuron, ethametsulfuron, ethametsulfuron-methyl, ethoxysulfuron, flazasulfuron, flucetosulfuron, flupyrsulfuron, flupyrsulfuron-methyl, foramsulfuron, halosulfuron, halosulfuron-methyl, imazosulfuron, iodosulfuron, iodosulfuron-methyl, iofensulfuron, mesosulfuron, metazosulfuron, metsulfuron, metsulfuronmethyl, nicosulfuron, orthosulfamuron, oxasulfuron, primisulfuron, primisulfuron-methyl, propyrisulfuron, prosulfuron, pyrazosulfuron, pyrazosulfuron-ethyl, rimsulfuron, sulfometuron, sulfometuron-methyl, sulfosulfuron, thifensulfuron, thifensulfuron-methyl, triasulfuron, tribenuron, tribenuron-methyl, trifloxysulfuron, triflusulfuron, triflusulfuron-methyl, tritosulfuron, and bentazone;
and their agriculturally useful derivatives.

43. The composition of claim 38, wherein the anionic herbicide (B) is selected from the group consisting of dicamba, 2,4-D, quizalofop, quizalofop-P, sethoxydim, clethodim and their agriculturally useful derivatives.

44. The composition of claim 38, wherein the anionic herbicide (B) is selected from the group consisting of dicamba and its agriculturally useful derivatives.

45. The composition of claim 38, wherein the anionic herbicide (B) is a combination of dicamba and glyphosate or their respective agriculturally useful derivatives.

46. A method for controlling unwanted vegetation, comprising allowing a herbicidally effective amount of the composition of claim 38 to act on plants, their seed and/or their habitat.
